(19) United States
(12) Patent Application Publication
(10) Pub. No.: US 2010/0281486 A1
(43) Pub. Date: Nov. 4, 2010

(54) Enhanced scheduling, priority handling and multiplexing method and system

(75) Inventors: Tsung-Liang Lu, Taipei City (TW); Yuanyuan Zhang, Beijing (CN); Chung-Shan Wang, Sinfong Township (TW); Chunli Wu, Beijing (CN)

Correspondence Address: BACON & THOMAS, PLLC, 625 SLATERS LANE, FOURTH FLOOR, ALEXANDRIA, VA, 22314-1176, US

(73) Assignee: HT mMobile Inc., Hsinchu Science Park (TW)

(21) Appl. No.: 12/662,757

(22) Filed: May 3, 2010

Related U.S. Application Data
(60) Provisional application No. 61/213,067, filed on May 4, 2009.
(60) Provisional application No. 61/286,432, filed on Dec. 15, 2009.

(51) Int. Cl. G06F 9/50

(52) U.S. Cl. 718/104

(57) ABSTRACT

System and method for enhancing scheduling/priority handling and multiplexing on transmitting data of different logical channels includes a receiver and a processor. The receiver receives a payload unit. The processor processes payload unit and enhances scheduling/priority handling and multiplex from different logical channels. The processor calculates data that can be transmitted with available resource for each logical channel, prioritizes the logical channels with decreasing priority order, performs first round resource allocation without partition, prioritizes logical channels with remaining data that is not performed with first round resource allocation with strict decreasing priority order, and performs second round resource allocation with partition. As such, scheduling/priority handling and the multiplexing in a multiple carrier system will be carried out so as to increase the efficiency of resource allocation.

### CROSS-REFERENCE TO RELATED APPLICATION

This application claims the benefit of filing dates of U.S. Provisional Application Ser. No. 61/213,067, entitled “Multiplexing Entity in LTE-Advanced CCA Compatible UE” filed May 4, 2009, and U.S. Provisional Application Ser. No. 61/286,432, entitled “An Enhanced Scheduling/Priority Handling and Multiplexing Mechanism in Multiple Carriers” filed Dec. 15, 2009 under 35 USC & 119(e)(1).

### BACKGROUND OF THE INVENTION

1. Field of the Invention

The invention relates generally to a scheduling, priority handling and multiplexing method and system and, more particularly, to an enhanced scheduling, priority handling and multiplexing method and system for performing scheduling, priority handling and multiplexing on different logical channels in Long Term Evolution Advanced (LTE-A).

2. Description of Related Art

Carrier Aggregation (CA), which means aggregating two or more component carriers (CCs) to be used by one user equipment (UE), is introduced in LTE-A as a key feature in order to support wider transmission bandwidth, e.g. from maximum 20 MHz in LTE Release 8 to maximum 100 MHz, and for spectrum aggregation. With the feature of CA, the achievable transmission data rate can be increased dramatically.

FIG. 1 shows the current Layer-2 structure of the LTE system. The Scheduling and Priority Handling entity 110 is responsible for resource allocation for the radio link control (RLC) service data units (SDUs) in each logical channel, based on the received uplink (UL) grants and the corresponding pre-configured prioritized bit rate (PBR). The multiplexing entity 120 is responsible for multiplexing medium access control (MAC) SDUs belonging to different logical channels as well as MAC control elements into one or more transport blocks meant for one or more CCs.

As shown in FIG. 1, The scheduling/priority handling and multiplexing method currently used in LTE is designed only for a single carrier (SC) system, and all linked to one hybrid automatic repeat request (HARQ) entity 130 of the single carrier. FIG. 2 shows a flow chart of the current logical channel prioritization method for scheduling/priority handling and multiplexing currently used in LTE.

FIG. 3 shows the Layer-2 structure in a multiple carrier (MC) system of the LTE-A system. As shown in FIG. 3, in a multiple carrier (MC) system, the scheduling/priority handling entity 310 and multiplexing entity 320 are linked to multiple HARQ entity 330 and each HARQ entity 330 corresponds to a CC, and UL grants for data transmission on each CC would be transmitted separately on corresponding physical downlink control channels (PDCCHs).

If two CCs will be aggregated for UL transmission, two UL grants with each indicating UL resource allocation on each CC will be received separately by the UE. The scheduling/priority handling 310 as well as the multiplexing 320 in a MC system will be different from the procedure in a single carrier system, as multiple UL grants and multiple HARQ entities should be considered jointly to achieve the efficiency of resource allocation.

Therefore, it is desirable to provide an enhanced scheduling, priority handling and multiplexing method and system to increase the efficiency of resource allocation.

### SUMMARY OF THE INVENTION

The object of the present invention is to provide an enhanced scheduling, priority handling and multiplexing method and system for performing scheduling, priority handling and multiplexing on different logical channels in a wireless communication network to increase the efficiency of resource allocation.

According to a feature of the invention, there is provided an enhanced scheduling, priority handling and multiplexing method for performing scheduling, priority handling and multiplexing on transmitting data of different logical channels, comprising the steps of: (A) calculating data that can be transmitted with available resource for each logical channel, wherein data of each logical channel is divided into prioritized bit rate (PBR) data and non-PBR data; (B) prioritizing the logical channels with strict decreasing priority order; (C) performing first round resource allocation without partition; (D) prioritizing logical channels with remaining data that is not served with first round resource allocation in step (C) with strict decreasing priority order; (E) performing second round resource allocation with partition.

According to another feature of the invention, there is provided an enhanced scheduling, priority handling and multiplexing method for performing scheduling, priority handling and multiplexing on transmitting data of different logical channels, comprising the steps of (A) calculating amount of data that can be transmitted for each logical channel with decreasing priority order, wherein data of each logical channel is divides into prioritized bit rate (PBR) data and non-PBR data; (B) prioritizing the logical channels with strict decreasing priority order; (C) initializing a first variable; (D) determining whether the first variable is equal to a number of logical channels having data available for transmission; (E) finding a UL grant or a combination of UL grants with least number of partitions if the first variable is not equal to the number of logical channels having data available for transmission; (F) allocating resource with the UL grant or the combination of UL grants for data of the m-th logical channel, where m is a value of the first variable; (G) calculating a number of UL grants not exhausted and corresponding remaining resource; (H) increasing the first variable and going to step (D).

According to a further feature of the invention, there is provided an enhanced scheduling, priority handling and multiplexing method for performing scheduling, priority handling and multiplexing on transmitting data of different logical channels, comprising the steps of (A) determining priorities of CCs assigned to a user equipment based on implicit rules; (B) calculating amount of data that can be transmitted for each logical channel, wherein data of each logical channel is divided into prioritized bit rate (PBR) data and non-PBR data; (C) prioritizing the logical channels with strict decreasing priority order; (D) prioritizing the UL grants with strict decreasing priority order; (E) performing first round resource allocation without partition; (F) prioritizing remaining logical channels that are not performed with first round resource allocation in step (E) with strict decreasing priority order; (G) prioritizing the UL grants not exhausted with strict decreasing priority order; (H) performing second round resource allocation with partition.

According to still a further feature of the invention, there is provided an enhanced scheduling, priority handling and multiplexing method for performing scheduling, priority handling and multiplexing on transmitting data of different logical channels, comprising the steps of: (A) determining priorities of CCs assigned to a user equipment based on implicit rules; (B) prioritizing the UL grants with strict decreasing priority order; (C) initializing a second variable; (D) determining whether the second variable is equal to a number of UL grants; (E) utilizing the c-th UL grant, where c is a value of the second variable; (F) prioritizing logical channel for single carrier (SC) according to the c-th UL grant; (G) increasing the second variable and executing step (D).

According to still a further feature of the invention, there is provided an enhanced scheduling, priority handling and multiplexing method for performing scheduling, priority handling and multiplexing on transmitting data of different logical channels, comprising the steps of: (A) determining priorities of CCs assigned to a user equipment based on implicit rules; (B) prioritizing the logical channels with strict decreasing priority order; (C) prioritizing the UL grants with strict decreasing priority order; (D) allocating resource for prioritized bit rate (PBR) data for each logical channel with the prioritized UL grant; (E) prioritizing the logical channels with non-PBR data with strict decreasing priority order; (F) prioritizing the UL grants not exhausted in step (D) with strict decreasing priority order; (G) performing first round resource allocation without partition; (H) prioritizing remaining logical channels that are not performed with first round resource allocation in step (G) with strict decreasing priority order; (I) prioritizing the UL grants not exhausted in step (G) with strict decreasing priority order; (J) performing second round resource allocation with partition.

According to still a further feature of the invention, there is provided an enhanced scheduling, priority handling and multiplexing method for performing scheduling, priority handling and multiplexing on transmitting data of different logical channels, comprising the steps of: (A) determining priorities of CCs assigned to a user equipment based on implicit rules; (B) calculating data that can be transmitted for each logical channel, wherein data of each logical channel is divided into prioritized bit rate (PBR) data and non-PBR data; (C) prioritizing the logical channels with strict decreasing priority order; (D) prioritizing the UL grants with strict decreasing priority order; (E) allocating resource for each logical channel with the prioritized UL grants.

According to still a further feature of the invention, there is provided an enhanced scheduling, priority handling and multiplexing system for performing scheduling, priority handling and multiplexing on transmitting data of different logical channels. The system comprises a receiver and a processor. The receiver receives a payload unit. The processor processes payload unit and enhancing scheduling, priority handling and multiplexing on the different logical channels, wherein the processor calculates data that can be transmitted with available resource for each logical channel, prioritizes the logical channels with strict decreasing priority order, performs first round resource allocation without partition, prioritizes logical channels with remaining data that is not performed with first round resource allocation with strict decreasing priority order, and performs second round resource allocation with partition.

According to still a further feature of the invention, there is provided an enhanced scheduling, priority handling and multiplexing system for performing scheduling, priority handling and multiplexing on transmitting data of different logical channels. The system comprises a receiver and a processor. The receiver receives a payload unit. The processor processes payload unit and enhancing scheduling, priority handling and multiplexing on the different logical channels, wherein the processor determines and maintains the priorities of received UL grants, each being associated to a component carrier (CC), manages the received UL grants sequentially or jointly as an overall UL grant when performing scheduling, priority handling and multiplexing on transmitting data of different logical channels.

According to still a further feature of the invention, there is provided an enhanced scheduling, priority handling and multiplexing system for performing scheduling, priority handling and multiplexing on transmitting data of different logical channels. The system comprises a receiver and a processor. The receiver receives a payload unit. The processor processes payload unit and enhancing scheduling, priority handling and multiplexing on the different logical channels, wherein the processor takes component carrier (CC) priority into consideration when performing scheduling, priority handling and multiplexing on transmitting data of different logical channels.

Other objects, advantages, and novel features of the invention will become more apparent from the following detailed description when taken in conjunction with the accompanying drawings.

### BRIEF DESCRIPTION OF THE DRAWINGS

FIG. 1 shows the current Layer-2 structure of the LTE system;

FIG. 2 shows a flow chart of the current logical channel prioritization method for scheduling, priority handling and multiplexing currently used in LTE;

FIG. 3 shows the Layer-2 structure in a multiple carrier (MC) system of the LTE-A system;

FIG. 4 is a block diagram of a wireless communication configured for scheduling, priority handling and multiplexing from different logical channels in LTE-A in accordance with invention;

FIG. 5 schematically illustrates MAC CE design baseline for the HARQ entity prioritization in accordance with the present invention;

FIG. 6 schematically illustrates PDCCH for the HARQ entity prioritization in accordance with the present invention;

FIG. 7 schematically illustrates a flow chart for UL grants that are treated sequentially in accordance with the present invention;

FIG. 8 schematically illustrates an example for the flow chart in FIG. 7 in accordance with the present invention;

FIG. 9 schematically illustrates a flow chart for UL grants that are treated jointly in accordance with the present invention;

FIG. 10 schematically illustrates an example for the flow chart in FIG. 9 in accordance with the present invention;

FIG. 11 schematically illustrates a flow chart for determining overall amount of available resource to transmit data of the logical channels in accordance with the present invention;

FIG. 12(A), FIG. 12(B), and FIG. 12(C) schematically illustrate a flow chart for calculating data from each logical channel that can be transmitted considering the remaining resource in accordance with the present invention;

FIG. 13 shows a flow chart for enhanced scheduling, priority handling and multiplexing method in accordance with the present invention;

FIG. 14 shows a flow chart of the first round resource allocation in accordance with the present invention;

FIG. 15 shows flow chart of the second round resource allocation in accordance with the present invention;

FIG. 16 schematically illustrates an example for the flow chart in FIG. 13 in accordance with the present invention;

FIG. 17 shows a flow chart of another embodiment for enhanced scheduling, priority handling and multiplexing method in accordance with the invention;

FIG. 18 shows a flow chart of an embodiment for enhanced scheduling, priority handling and multiplexing method for performing scheduling, priority handling and multiplexing on different logical channels with taking CC priority into consideration in accordance with the invention;

FIG. 19 shows a flow chart of another embodiment for enhanced scheduling, priority handling and multiplexing method for performing scheduling, priority handling and multiplexing on different logical channels with taking CC priority into consideration in accordance with the invention;

FIG. 20 schematically illustrates an example for the flow chart in FIG. 19 in accordance with the invention;

FIG. 21 shows a flow chart of further another embodiment for enhanced scheduling, priority handling and multiplexing method for performing scheduling, priority handling and multiplexing on different logical channels with taking CC priority into consideration in accordance with the invention;

FIG. 22 schematically illustrates an example for the flow chart in FIG. 21 in accordance with the invention;

FIG. 23 shows a flow chart of further another embodiment for enhanced scheduling, priority handling and multiplexing method for performing scheduling, priority handling and multiplexing on different logical channels with taking CC priority into consideration in accordance with the invention;

FIG. 24 schematically illustrates an example for the flow chart in FIG. 23 in accordance with the invention;

FIG. 25 schematically illustrates a flow chart to realize the non-PBR data multiplexed with PBR data into the same transport block in accordance with the invention;

FIG. 26 schematically illustrates another flow chart to realize the non-PBR data multiplexed with PBR data into the same transport block in accordance with the invention;

FIG. 27 shows a flow chart of further another embodiment for enhanced scheduling, priority handling and multiplexing method for performing scheduling, priority handling and multiplexing on different logical channels with taking CC priority into consideration in accordance with the invention; and

FIG. 28 schematically illustrates an example for the flow chart in FIG. 27 in accordance with the invention.

### DETAILED DESCRIPTION OF THE PREFERRED EMBODIMENT

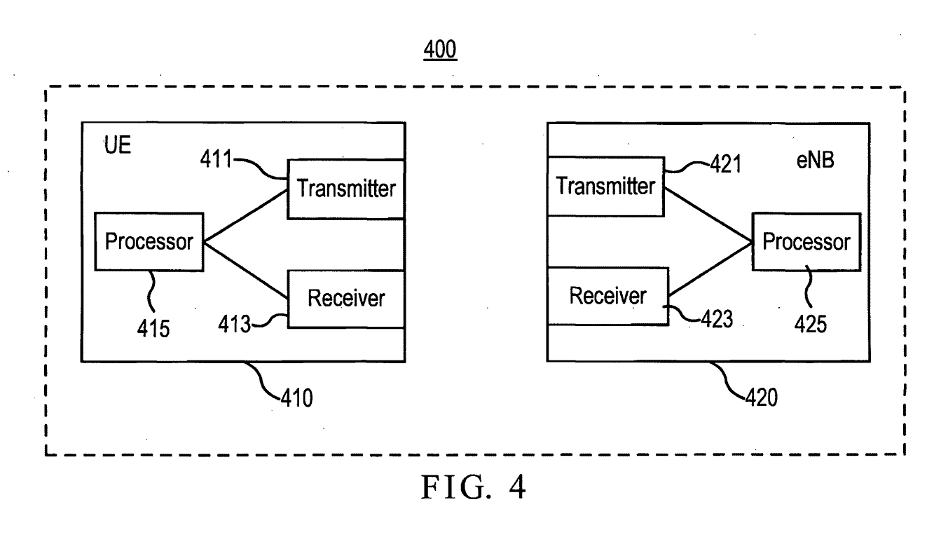

FIG. 4 is a block diagram of a wireless communication system 400 in which an enhanced scheduling, priority handling and multiplexing method is executed to perform scheduling, priority handling and multiplexing on different logical channels in LTE-A in accordance with invention. The system 400 includes a base station (eNB) 420 and a user equipment (UE) 410. The UE 410 and the eNB 420 communicate with each other by a wireless communication link.

As shown in FIG. 4, the UE 410 comprises a transmitter 411, a receiver 413, and a processor 415. The receiver 413 is configured to receive a payload unit, and the processor 415 is configured to process payload unit and enhances the operation of scheduling, priority handling and multiplexing on different logical channels. The processor 415 determines and maintains the priorities of received UL grants, with each being associated to a component carrier (CC), manages the received UL grants sequentially or jointly as an overall UL grant when performing scheduling, priority handling and multiplexing on transmitting data of different logical channels. The processor 415 also calculates data that can be transmitted with available resource for each logical channel, prioritizes the logical channels with strict decreasing priority order, performs first round resource allocation without partition, prioritizes logical channels with remaining data that is not served with first round resource allocation with strict decreasing priority order, and performs second round resource allocation with partition.

Carrier aggregation (CA) will be supported in the LTE-Advanced system. The intention of CA technique is to support a bandwidth larger than 20 MHz in order to fulfill the requirement of the data transmission rate higher than 1 Gbits/s. In the 3GPP RAN2 65bis meeting, it is defined that each component carrier will have separate HARQ entity. It is likely that the HARQ entity of the different component carrier will be linked to the joint multiplexing entity.

The multiplexing entity is responsible for resource allocation of the logical channel data based on the received uplink grant and the pre-configured prioritized bit rate (PBR) of the logical channel.

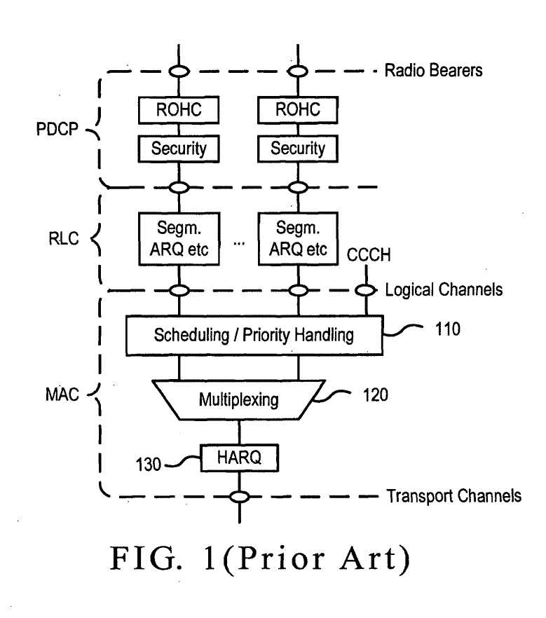

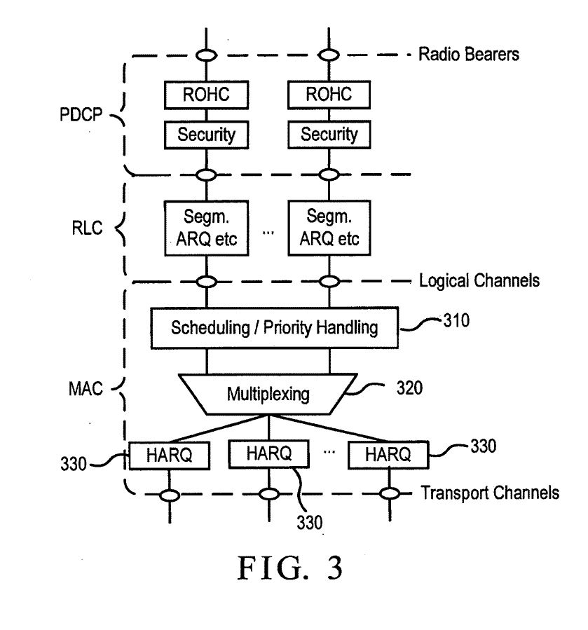

As shown in FIG. 1 and FIG. 3, it is known that the difference between the CA and non-CA system is that in the CA system the multiplexing entity 320 is linked to several HARQ entities 330 and in non-CA system the multiplexing entity 120 is linked only to one HARQ entity 130. How the multiplexing entity 320 is implemented with multiple HARQ entities 330 could have different features/functionalities comparing with the case with only one HARQ entity 130.

The multiplexing entity 320 in a CA compatible UE could allocate the logical channel data, i.e. MAC SDUs, to different HARQ entities 330 and allocate corresponding uplink resource accordingly.

In the invention, the HARQ entities are prioritized and the multiplexing entities in a CA compatible UE could allocate the data according to the prioritization. When UE performs multiplexing of MAC PDUs for each component carrier, it could follow the rule of logical channel prioritization for each component carrier, while the transport block (TB) for higher priority HARQ entity is multiplexed before the TB for lower priority HARQ entity. The HARQ entity prioritization could be determined by the UE by internal rules without explicit signaling from the eNB, i.e. implicitly. As another possible embodiment, the eNB could set the prioritization of the HARQ entities according to the feedback of the UE. The feedback of the UE could be the channel quality information of each UL component carrier, e.g. the SRS (Sounding Reference Signal) of each UL component carrier.

In the invention, the prioritization of the HARQ entity could be signaled from eNB 420 to UE 410 in different way by using RRC configuration message, MAC control element, extended PDCCH format or an implicit rule in UE 410.

### RRC Signaling

In one embodiment of the invention, the UE 410 configures the priority of the HARQ entity 330 in CA by using an RRC message. The configuration message could be broadcasted by the eNB 420 as system information or through a dedicated RRC signaling. The UE 410 can reconfigure the priority of the HARQ entity by using RRC message. The reconfiguration message could be broadcasted by the eNB 420 as system information or send through a dedicated RRC signaling.

### MAC Control Signaling

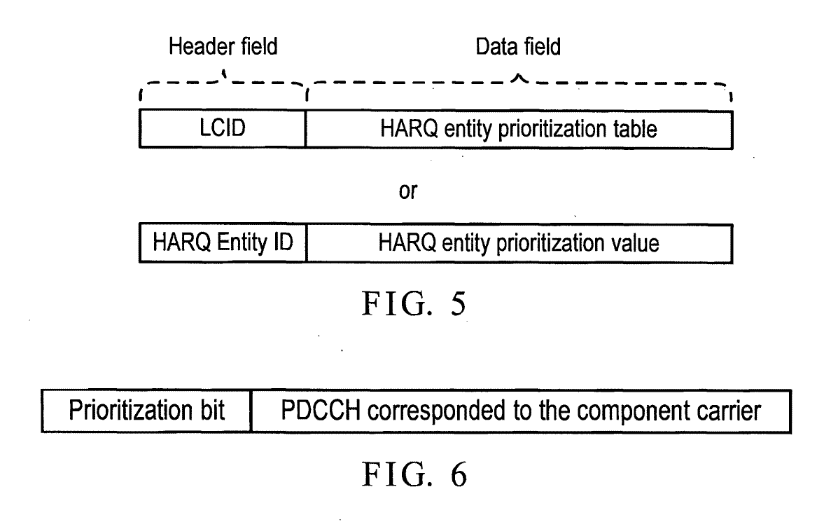

In another embodiment of the invention, the UE 410 configures the priority of the HARQ entity 330 in CA system by using MAC control element (CE). FIG. 5 schematically illustrates MAC CE design baseline for the HARQ entity 330 prioritization in accordance with the present invention. The MAC control element contains an MAC header field and a data field. In the header field, LCID could be used to indicate the MAC CE or a dedicated HARQ entity. In the data field, a prioritization table of the HARQ entities or the prioritization of the single HARQ entity is included.

### Extended PDCCH Format

In further embodiment of the invention, the UE 410 configures the priority of the HARQ entity 330 in CA system by using physical downlink control channel (PDCCH). FIG. 6 schematically shows PDCCH for the HARQ entity prioritization in accordance with the present invention. The PDCCH format indicates the granted UL resource for each component carrier; e.g. for each HARQ entity 330 in CA, there could be an associated PDCCH indicated the granted UL resource. The PDCCH format could be extended to carry the prioritization information of each HARQ entity 330; for example, priority bit is added to the PDDCH indicating the granted UL resource corresponding to the component carrier, where the number of the bits is based on the maximum number of possible UL component carriers according to the UE capability.

### Implicit HARQ Entity Priority Assignment in UE

In still further embodiment of the invention, UE 410 could assign the HARQ entity 330 priority based on an implicit rule, i.e. without an explicit signaling from the eNB 420. The assignment of the HARQ entity 330 priority is based on the size of the allocated resources of each component carrier (CC). For example, if one component carrier (component carrier A) is allocated much more resource than another component carrier (component carrier B), the HARQ entity 330 corresponding to the component carrier A is implicitly assigned to higher/lower priority in comparison with component carrier B.

Another implicit rule could be based on the frequency of the component carrier, e.g. the HARQ entity 330 of the component carrier (CC) with lowest carrier frequency has the highest priority. Different carrier frequencies could also be assigned with different priorities, and the HARQ entities 330 corresponding to different carriers could be implicitly assigned with same prioritization setting.

Still another implicit rule could be based on the channel quality of the corresponding component carrier, e.g. the HARQ entity 330 of the component carrier (CC) with worst channel quality has the lowest priority. For example, the channel quality may be determined from the corresponding downlink component carrier.

When UE 410 allocates the UL resource, it uses the prioritized bit rate (PBR) to allocate the logical channel data. For each logical channel j, there is a defined prioritized bit rate (PBRj). When applying CA in the LTE-Advanced system, the prioritized bit rate (PBR) could be dependent on the size of the allocated resource on each component carrier. For example if one component carrier (component carrier A) is allocated with Na resource blocks (RBs) and another component carrier (component carrier B) is allocated with Nb RBs, UE 410 assigns PBRj*Na/(Na+Nb) to the HARQ entity 330 corresponding to the component carrier A for resource allocation in the logical channel j, and PBRj*Nb/(Na+Nb) to the HARQ entity 330 corresponding to the component carrier B for resource allocation in the logical channel j.

If the total number of component carriers is N, the modified PBR_{i,j} for the logical channel j used for resource allocation on the component carrier i can be expressed as:

$${PBR}_{i , j} = {PBR}_{j} * \frac{{N}_{i}}{{\sum }_{i = 1}^{N} {N}_{i}} ,$$

where Ni is the number of the allocated RBs on the component carrier I and PBRj is the original defined PBR for the logical channel j.

The modified PBR_{i,j} for the logical channel could be further enhanced with a weight factor. If the total number of component carriers is N, the modified PBR_{i,j} for the logical channel j used for resource allocation on the component carrier i can be expressed as:

$${PBR}_{i , j} = {Q}_{j} {PBR}_{j} * \frac{{N}_{i}}{{\sum }_{i = 1}^{N} {N}_{i}} ,$$

where Ni is the number of the allocated RBs on the component carrier i and PBRj is the original defined PBR for the logical channel j and Qj is the weight factor for the logical channel j.

In another embodiment, the UE 410 could also distribute the logical channel data equally among the component carriers. If there are N component carriers, the UE 410 could allocate the resource to the logical channel on one component carrier using PBRj/N.

When multiple UL grants are received by UE 410, there are two possible methods to utilize the UL grant when performing, scheduling, priority-handling and multiplexing.

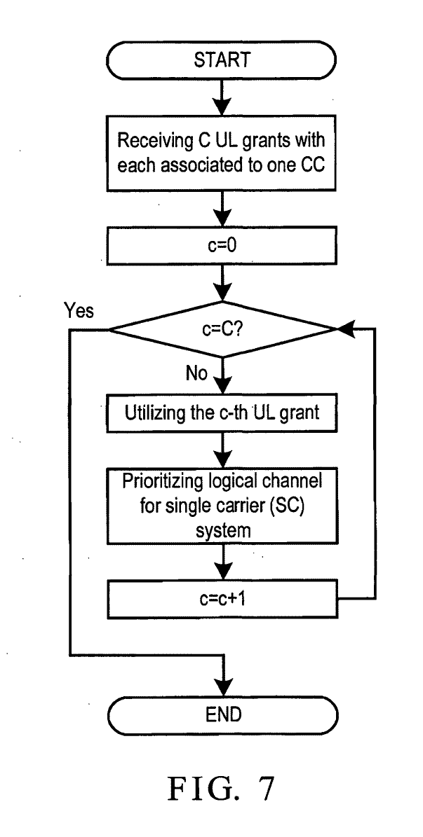

The first one is to treat multiple UL grants sequentially and the second one is to treat the multiple UL grants jointly and as an overall UL grant. FIG. 7 schematically illustrates a flow chart for UL grants that are treated sequentially in accordance with the present invention. As shown in FIG. 7, M is the number of logical channels which have data available for transmission and C is the received UL grant number. The UE 410 applies current logical channel prioritization procedure on each carrier, and the UE 410 will start to allocate data to another carrier only after exhausting the UL grant of one carrier.

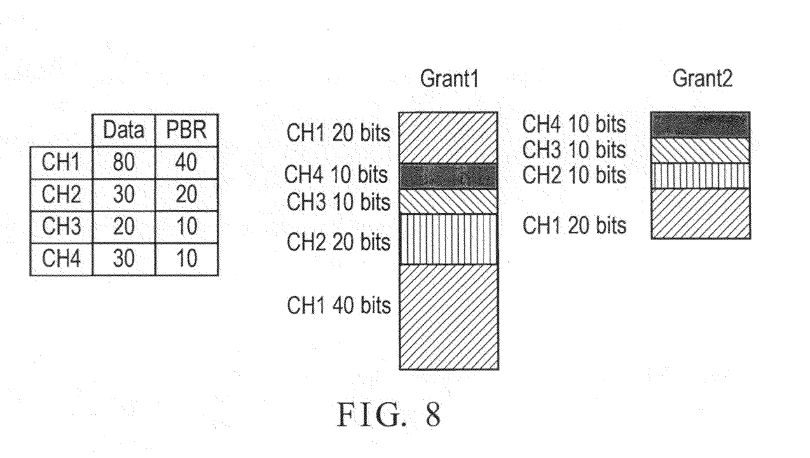

FIG. 8 schematically illustrates an example in accordance with the flow chart in FIG. 7. As shown in FIG. 8, there are two CCs aggregated for UL transmission, and two UL grants will be received, each indicating the resource allocation on one of the CCs respectively. At a certain transmission time interval (TTI), two UL grants are received on PDCCH with Grant 1=100 bits and Grant 2=50 bits. There are four logical channels having data available for transmission, whereas logical channel 1 (CH1) has 80 bits, logical channel 2 (CH2) has 30 bits, logical channel 3 (CH3) has 20 bits, logical channel 4 (CH4) has 30 bits for transmission respectively. It assumes that the PBRs from logical channel 1 to logical channel 4 are PBR1 with 40 bits, PBR2 with 20 bits, PBR3 with 10 bits, PBR4 with 10 bits, respectively. For simplicity, the bucket variable B1 to B4 are larger than the available grants for all logical channels. Logical channels 1-4 are prioritized with decreasing priority order in which logical channel 1 has highest priority and logical channel 4 has lowest priority.

As shown in FIG. 8, Grant 1 is treated first. Data of different logical channels are fit into Grant 1 with decreasing priority order from CH1 to CH4. The resource allocation should meet the PBRs for each logical channel. Therefore, 40 bits from CH1, 20 bits from CH2, 10 bits from CH3 and 10 bits from CH4 are fit into Grant 1 first. After the satisfaction of PBRs, there are 20 bits left in Grant1.

There are 20 bits left in Grant 1, and 20 bits from CH1 are fit into the remaining space of Grant1. Grant1 is exhausted and there is no capacity left in Grant1.

The remaining data of logical channels are fit into Grant 2 with decreasing priority order from CH1 to CH4. The logical channels are served in a strict decreasing priority order. Therefore, 20 bits from CH1, 10 bits from CH2, 10 bits from CH3 and 10 bits from CH4 are fit into Grant2.

The method shown in FIG. 7 has the advantage that the procedure in Release 8 can be completely reused. However, with this method, the optimum resource allocation efficiency may not be achieved due to the loss of flexibility. More overhead from MAC header will be introduced because Radio Link Control Service Data Units (RLC SDUs) from the same logical channel are multiplexed to different transport block. Furthermore, as different CCs may have different channel quality, so RLC SDUs from the same logical channel may experience different radio condition, which will result in the data stun in higher priority logical channel if the channel quality of the other CC is not good enough.

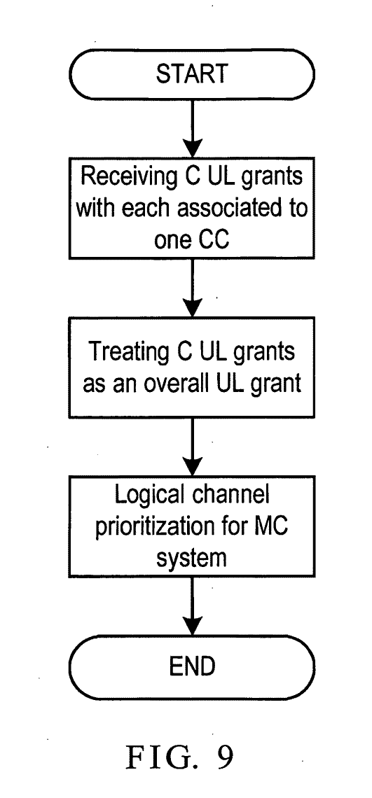

The second one is to treat the multiple UL grants jointly and as an overall UL grant. FIG. 9 schematically illustrates a flow chart for UL grants that are treated jointly. As shown in FIG. 9, the UE 410 considers the overall available grants and total data from different logical channels. The UE 410 can allocate data to another carrier before exhausting the UL grant of one carrier.

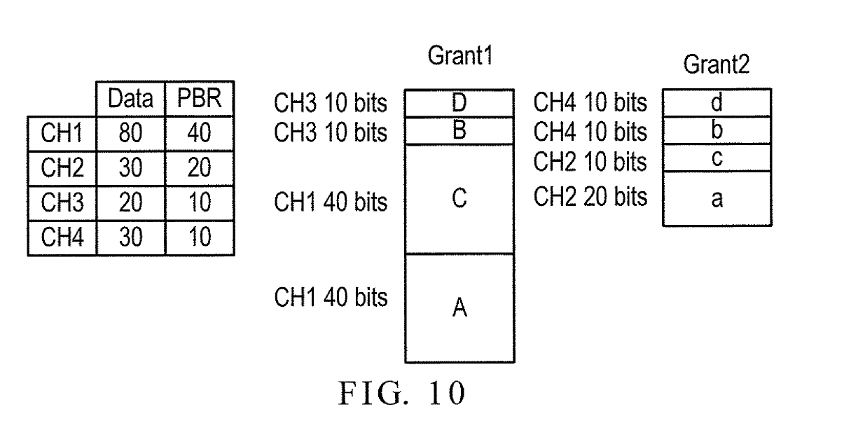

FIG. 10 schematically illustrates an example in accordance with the flow chart in FIG. 9. The UL grants are treated jointly and, just as illustrated in FIG. 10, Grant1 and Grant2 are treated together as an overall UL grant.

Logical channels are fit into the overall grant with decreasing priority order from CH1 to CH4. The resource allocation should meet the PBRs for each logical channel. Therefore, 40 bits from CH1, 20 from bits CH2, 10 bits from CH3 and 10 bits from CH4 are fit into Grant1 and Grant2, in the region A of Grant1, the region a of Grant2, the region B of Grant1, and the region b of Grant2 respectively. Thus, there are 50 bits left in Grant1 and 20 bits left in Grant2.

As there are 70 bits left in the overall grant, 40 bits from CH1 are fit into the region C of Grant1. There are 30 bits left in the overall grant, and 10 bits from CH2 are fit into the region c of Grant2.

There are 20 bits left in the overall grant, and 10 bits from CH3 are fit into the region D of Grant1. There is no space left in Grant 1.

There are 10 bits left in the overall grant, and 10 bits from CH4 are fit into the region d of Grant2.

The method in FIG. 9 has the advantage that flexibility of resource allocation can be achieved. While the PBRs of logical channels should be guaranteed during resource allocation to logical channels, it should be avoided that RLC SDUs from the same logical channel are multiplexed into different transport blocks, which will be transmitted on different CCs. Hereinafter the invention defines the target as “Partition Avoidance”; that is UE should keep the data of the same logical channel in the same grant as much as possible. The terminology Partition means the RLC SDUs or the data available for transmission from the same logical channel is multiplexed into different transport block.

A method to achieve the Partition Avoidance is to first calculate the data that can be transmitted with the available resource for each logical channel with decreasing priority order (taking PBR and non-PBR data and Bj into consideration), and then RLC SDUs from each logical channel should be tried to be fit into only one CC. And only the calculated amount of data from each logical channel would be fit into the UL grants.

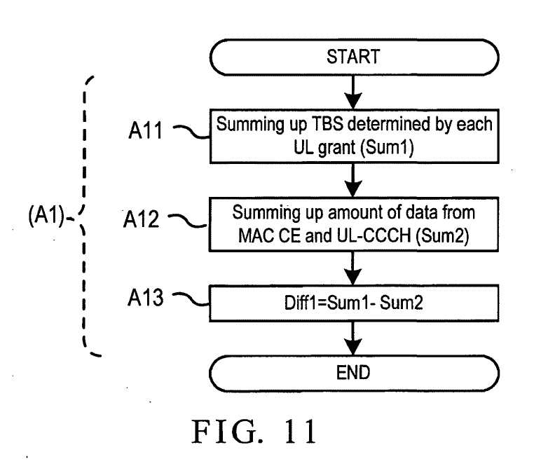

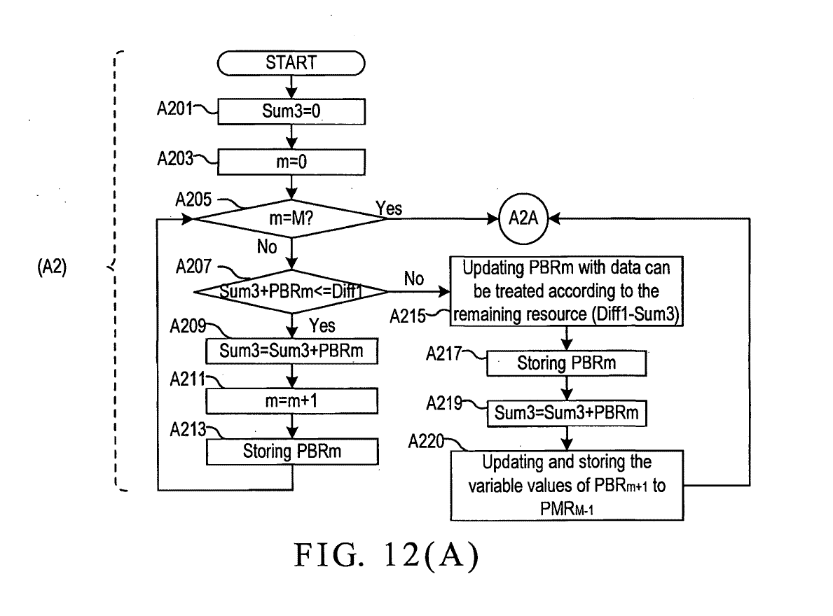

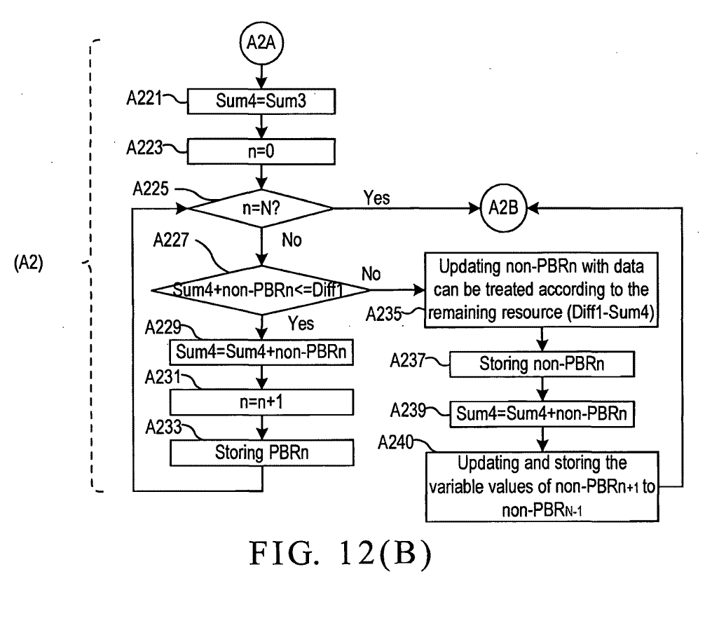

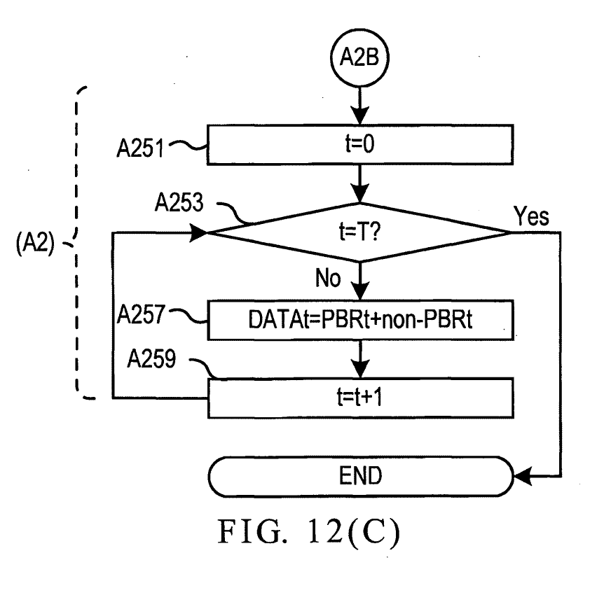

To calculate data that can be transmitted with available resource for each logical channel, wherein data of each logical channel is divided into prioritized bit rate (PBR) data and non-PBR data, it first determines overall amount of available resource to transmit data of the logical channels which can be transmitted with uplink (UL) grants, as described by step (A1) shown in FIG. 11. Then, it calculates data from each logical channel that can be transmitted considering the remaining resource calculated in step (A1), as described by step (A2) shown in FIG. 12(A), FIG. 12(B), and FIG. 12(C).

With reference to FIG. 11, as the multiple UL grants are treated jointly and as an overall UL grant, in step A11, UE 410 first calculates the overall amount of data which can be transmitted with the granted UL resource to generate a first number Sum1. In fact the overall amount of data is equivalent to the summation of transport block size (TBS) determined by the corresponding UL grant. The method for TBS determination is specified in 3GPP specification 36.213, and is even further beyond the invention.

During the progress of calculation, the MAC Control Element (MAC CE) and data from UL-CCCH are considered having higher priority over data from any other logical channel. Therefore, the amount of data from MAC CE(s) and UL-CCCH should be estimated and calculated and summed up together first before taking data form other logical channels into consideration. The total amount of data with high priority can be obtained/estimated first, and cannot exceed the overall available resource Sum1. Thus, in step A12, it sums up the amount of data from MAC CE and UL-CCCH to generate a second number Sum2.

Then the overall amount of data from the logical channels except data from UL-CCCH which can be transmitted with the granted UL resource can be determined. In step A13, the second number Sum2 is subtracted from the first number Sum1 to generate a third number Diff1. It is the available resource that remains after the total amount of data with high priority is subtracted from the summation of TBS with the overall UL grant. It is known that Diff1 represents the remaining available resource that can be used to transmit data. If Diff1 equals to zero, there's no more available resource to transmit data from other logical channel, and the whole procedure ends.

With reference to FIG. 12(A), in step A201 and step A203, it initializes a variable Sum3 and a variable m. Variable Sum3 represents the total amount of PBR data that can be transmitted with remaining resource.

In step A205, it determines whether the variable m is equal to a number (M) of logical channels having PBR data available for transmission. If the variable m is not equal to the number M, it further determines whether the summation of variable Sum3 and a variable PBRm is not greater than the number Diff1 (step A207), wherein variable PBRm represents PBR data that can be transmitted for the m-th logical channel. If the variable m is equal to the number M, the process goes to the flow chart of FIG. 12(B).

If the summation of variable Sum3 and the variable PBRm is not greater than the number Diff1, it sums the variable Sum3 and the variable PBRm and assigns the result into the variable Sum3 (Step A209); otherwise, it updates the variable PBRm with data that can be treated according to the remaining resource (Diff1-Sum3) in step A215.

In step A211 and step A213, it increases the variable m and stores the variable PBRm respectively, then executes step A205.

In step A217, it stores the variable PBRm. In step A219, it sums the variable Sum3 and the variable PBRm and assigns the result into the variable Sum3. In step A220, it updates and stores the variable values of PBRₘ₊₁ to PBR_{M-1}, and then the process goes to the flow chat of FIG. 12(B).

From FIG. 12(A), it can be seen that the PBR data from each logical channel should be guaranteed first. The PBR data from each logical channel in a decreasing priority order will be summed one by one. The arithmetic operation of summing will stop until either the PBR data from all logical channels with PBR data are counted, or the remaining resource is exhausted, whichever comes first. Meanwhile the amount of PBR data for each logical channel counted in (PBRm) should be stored.

With reference to FIG. 12(B), in step A221 and step A223, it initializes a variable Sum4 and a variable n. Variable Sum4 represents the total amount of data can be transmitted with remaining resource (Diff1).

In step A225, it determines whether the variable n is equal to a number (N) of logical channels having non-PBR data available for transmission. If the variable n is not equal to the number N, it further determines whether the summation of the variable Sum4 and a variable non-PBRn is not greater than the number Diff1 (step A227), wherein variable non-PBRn represents non-PBR data can be transmitted for the n-th logical channel. If the variable n is equal to the number N, the process goes to the flow chart of FIG. 12(C).

If the summation of variable Sum4 and the variable non-PBRn is not greater than the number Diff1, it sums the variable Sum4 and the variable non-PBRn and assigns the result into the variable Sum4 (Step A229); otherwise, it updates the variable non-PBRn with data that can be treated according to the remaining resource (Diff1-Sum4) in step A235.

In step A231 and step A233, it increases the variable n and stores the variable non-PBRn respectively, then executes step A225.

In step A237, it stores the variable non-PBRn. In step A237, it sums the variable Sum4 and the variable non-PBRn and assigns the result into the variable Sum4. In step A240, it updates and stores the variable values of non-PBRₙ₊₁ to non-PBR_{N-1}, and then the process goes to flow chart of FIG. 12(C).

From FIG. 12(B), it is known that if any resource remains, the non-PBR data from each logical channel in a decreasing priority order will be added one by one with the total amount of the PBR data from all the logical channels. The arithmetic operation of summing will stop untill either the non-PBR data from all logical channels with non-PBR data are counted, or the remaining resource is exhausted, whichever comes first. Meanwhile the amount of non-PBR data for each logical channel counted in non-PBRn should be stored.

With reference to FIG. 12(C), in step A251, it initializes a variable t represents an index of logical channel.

In step A205, it determines whether the variable t is equal to a number (T) of logical channels having data available for transmission. If the variable t is not equal to the number T, it sums a variable PBRt and a variable non-PBRt and assigns the result into the variable DATAt (Step A227), wherein variable PBRt represents PBR data that can be transmitted for the t-th logical channel, variable non-PBRt represents non-PBR data that can be transmitted for the t-th logical channel, and variable DATAt represents a total amount of data that can be transmitted for the t-th logical channel.

In step A259, it increases the variable t, then executes step A253. If the variable t is equal to the number T, the process ends.

Once the arithmetic operation of summing is stopped, the data that can be transmitted with the available resource for each logical channel can be derived. It is the sum of amount of PBR data and non-PBR data stored for each logical channel.

By running the steps in FIG. 12(A), FIG. 12(B), and FIG. 12(C), and also taking the possible MAC PDU sub-headers that would be fit into the UL grants into consideration, it can calculate the overall data from each logical channel that can be transmitted considering the remaining resource calculated in Step (A1). And only the calculated overall amount of data from each logical channel would be fit into the UL grants.

In some specific cases, partition avoidance in the invention cannot be guaranteed for all the logical channels when the network doesn't know exactly the amount of data available for transmission of each logical channel. One enhancement of the partition avoidance is to guarantee the avoidance for higher priority logical channel before considering the lower priorities ones, unless the data that can be transmitted from the higher priority logical channel is too large to be fit in only one UL grant. In that case, the higher priority logical channel is not served in the first round resource allocation, which will be described in next.

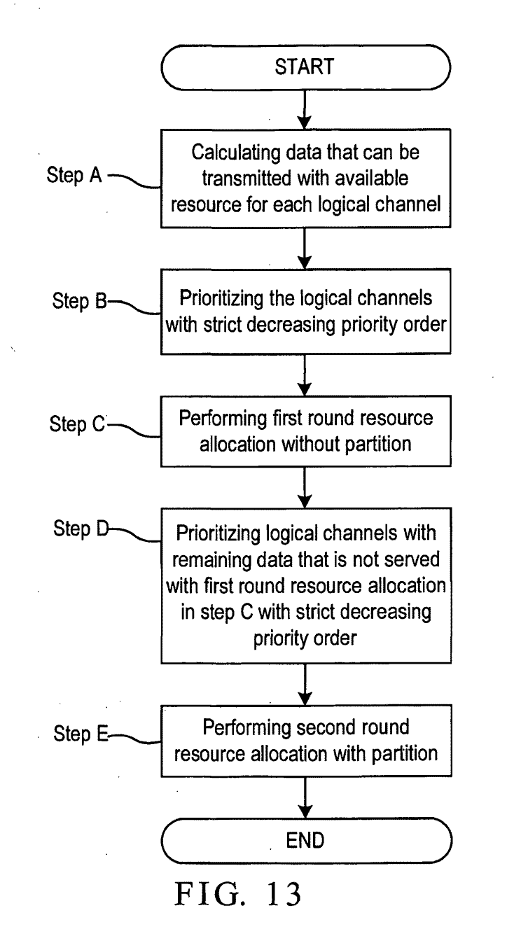

FIG. 13 shows a flow chart for enhanced scheduling, priority handling and multiplexing method for performing scheduling, priority handling and multiplexing on different logical channels in accordance with the present invention.

As shown in. FIG. 13, it first calculates data that can be transmitted with available resource for each logical channel (step A), wherein data of each logical channel is divided into prioritized bit rate (PBR) data and non-PBR data. The detail flows can refer to FIG. 12(A), FIG. 12(B), and FIG. 12(C) for calculating data that can be transmitted with available resource for each logical channel. And only the calculated amount of data from each logical channel would be fit into the UL grants.

In step B, it prioritizes the logical channels with strict decreasing priority order in which the logical channel with lower logical channel priority value has high priority. For example, logical channel 1 (CH1) can have higher priority than logical channel 2 (CH2) by configuration.

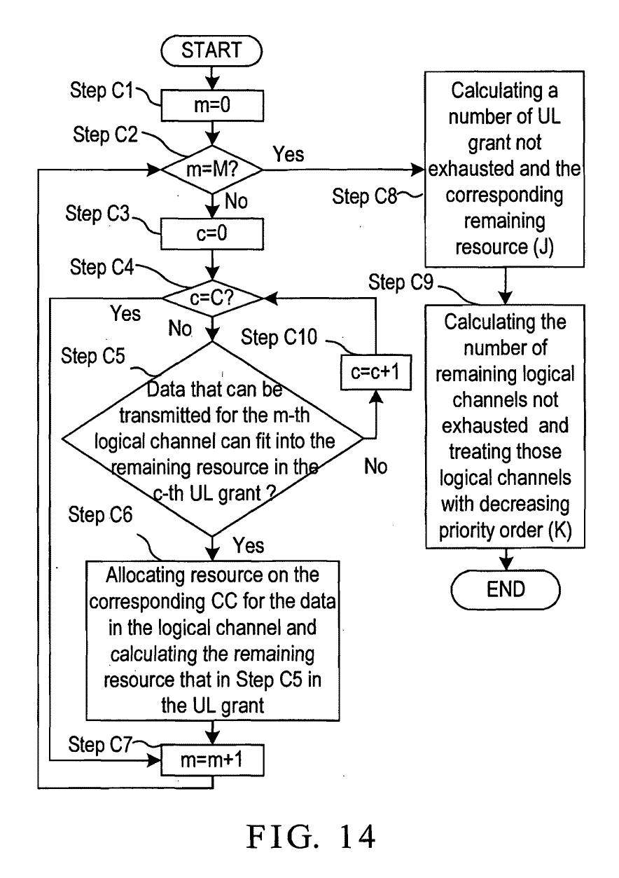

In step C, it performs first round resource allocation without partition. The detail flow of first round resource allocation without partition is shown in FIG. 14.

In step D, it prioritizes logical channels with remaining data that is not served with first round resource allocation in step (C) with strict decreasing priority order.

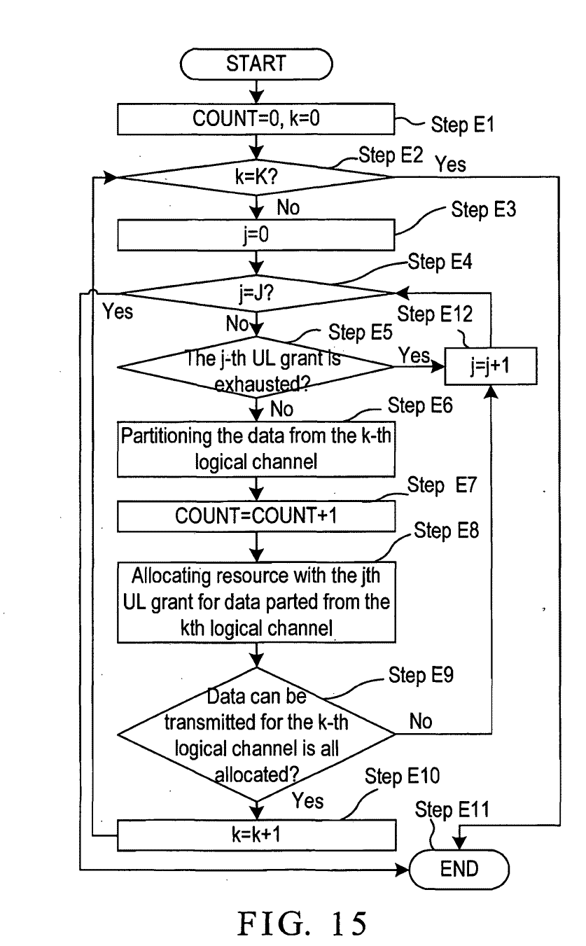

In step E, it performs second round resource allocation with partition that is described more detail in FIG. 15.

As shown in FIG. 13, it is known that in the first round resource allocation the logical channels are served with strict decreasing logical channel priority order, and thus the partition avoidance for higher priority logical channel can be guaranteed and the efficiency of resource allocation can be dramatically increased, unless the corresponding data amount is too large to be fit in only one UL grant.

FIG. 14 shows a flow chart of the first round resource allocation in accordance with the present invention. The first round resource allocation aims to allocate resource for the logical channel which can be fit into only one UL grant. In step C1, it initializes a variable m. Variable m represents an index of logical channels which have data available for transmission.

In step C2, it determines whether the variable m is equal to a number (M) of logical channels having data available for transmission.

In step C3, it initializes a variable c if the variable m is not equal to the number M of logical channels having data available for transmission. Variable c represents an index of received UL grants. In step C4, it determines whether the second variable c is equal to a number (C) of received UL grants.

In step C5, it determines whether data that can be transmitted for an m-th logical channel can be fit into remaining resource in a c-th UL grant if the variable c is not equal to the number (C) of received UL grant.

In step C6, it allocates resource on the c-th UL grant for the data in the m-th logical channel and calculates the remaining resource in the c-th UL grant. In step C7, it increases the variable m and then executes step C2.

In step C8, it calculates a number (J) of UL grants not exhausted and remaining resource of the UL grants not exhausted if the variable m is equal to the number M of logical channels having data available for transmission.

In step C9, it calculates a number (K) of remaining logical channels not exhausted, treats those logical channels with decreasing priority order, and then executes step (D) in FIG. 13.

In step C10, it increases the variable c and then executes step C4.

As shown in FIG. 14, the logical channels are served one after another with a specific order that can be defined using different criterion, e.g. the logical channel priorities. The data in each logical channel corresponding to the calculated available resource should be fit in only one UL grant without partition. If the data in the logical channel cannot be fit into the UL grant without partition, it will not be served in the first round resource allocation and will be served in the second round resource allocation.

The UL grants are tried one after another with a specific order that can be defined using different criterion, e.g. the grant size, until the suitable UL grant is found. The remaining resource in the UL grant will be calculated accordingly after the data in the logical channel has been fit in it. Then all the other logical channels will be tried sequentially with the method disclosed in FIG. 14 to be fit in the remaining resource in only one UL grant. After the first round resource allocation, the number of the UL grant not exhausted (i.e. J) as well as the corresponding resource and the number of remaining logical channels not served (i.e. K) will be calculated and used in the second round resource allocation.

FIG. 15 shows flow chart of the second round resource allocation in accordance with the present invention. The second round resource allocation aims to allocated resource for the remaining logical channels with the remaining resource in the UL grants which are not exhausted.

In step E1, it initializes a variable k and a variable COUNT.

In step E2, it determines whether the variable k is equal to the number (K) of remaining logical channels not exhausted that is calculated in step C9 in FIG. 14.

In step E3, it initializes a variable j if the variable k is not equal to the number (K) of remaining logical channels not exhausted.

In step E4, it determines whether the variable j is equal to the number (J) of UL grants not exhausted that is calculated in step C8 in FIG. 14.

In step E5, it further determines whether the j-th UL grant is exhausted if the variable j is not equal to the number (J) of UL grants not exhausted. In step E6, it partitions data from the k-th logical channel. In step E7, it increases the variable COUNT.

In step E8, it allocates resource with the j-th UL grant for data partitioned from the k-th logical channel in step E6. In step E9, it determines whether data that can be transmitted for the k-th logical channel is all allocated.

In step E10, it increases the variable k if data that can be transmitted for the k-th logical channel is all allocated and executes step E2, otherwise, it increases the variable j and executing step E4.

In step E11, it ends the method if the variable k is equal to the number (K) of remaining logical channels not exhausted or the variable j is equal to the number (J) of UL grants not exhausted.

As shown in FIG. 15, in the second round resource allocation, partition cannot be avoided. The remaining resource in the UL grants not exhausted is considered as a resource pool. The remaining logical channels are served one after another. The data that can be transmitted in each remaining logical channel will be fit into the remaining resource until the UL grants are exhausted or no more data left in all logical channels.

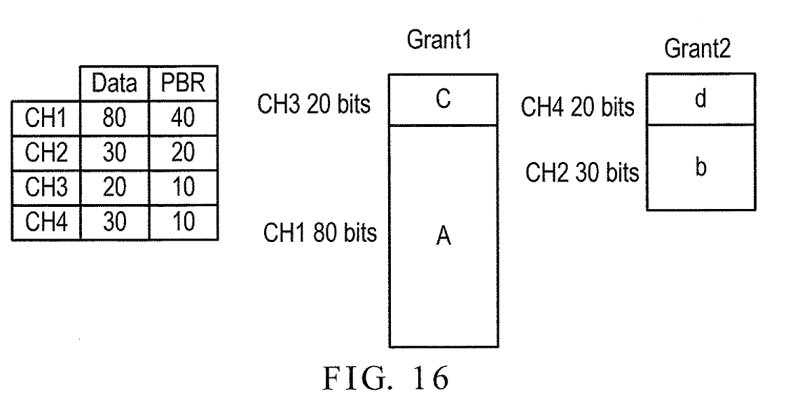

FIG. 16 schematically illustrates an example in accordance with the flow chart in FIG. 13. With reference to FIG. 13 and FIG. 16, in the first round resource allocation, there are only 50 bits available in Grant2, thus the method allocates 80 bits in Grant1 for avoiding data partition in data transmission of CH1, and there are 20 bits left in Grant1.

Because only 20 bits are left in Grant1 and it needs 30 bits for transmission of CH2, the method allocates 30 bits in Grant2 for avoiding data partition in data transmission of CH2. Grant1 has 20 bits left and Grant2 has 20 bits left.

The method allocates 20 bits in Grant1 for avoiding data partition in data transmission of CH3, and Grant1 has no capacity for further allocation.

In the second round resource allocation, the method allocates 20 bits in Grant2 for transmitting data of CH4 with data partition.

As such, the partition avoidance for higher priority logical channel is guaranteed in the first round resource allocation and the efficiency of resource allocation is thus increased.

The method disclosed in FIG. 13 has a disadvantage that the data that can be transmitted from the higher priority logical channel will be partitioned several times if the data amount of the higher priority logical channel is too large to be fit in only one UL grant, especially as the UL grants have already been allocated to lower priority logical channel which can be fit into only one UL grant.

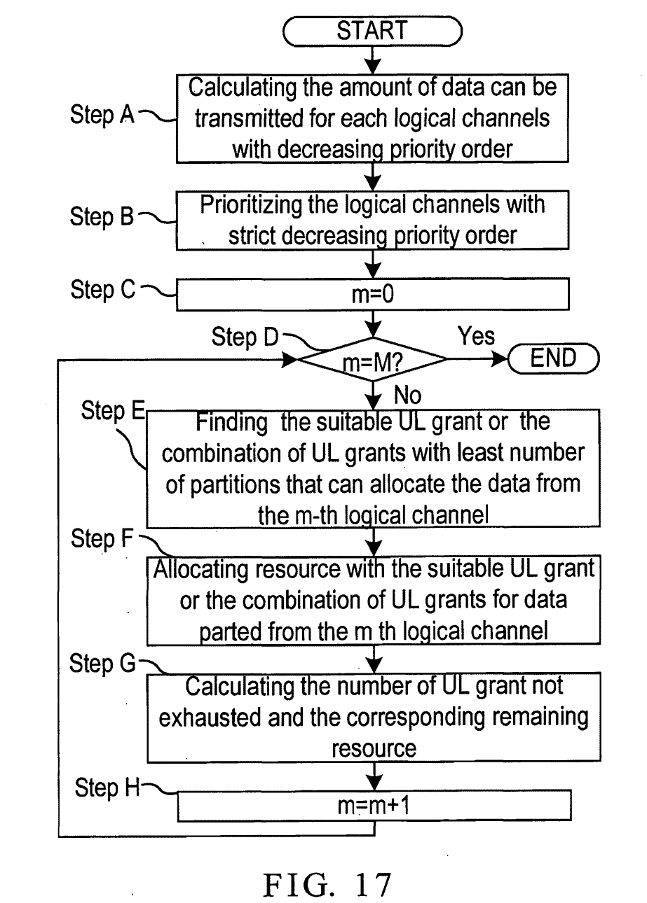

FIG. 17 shows a flow chart of another embodiment for enhanced scheduling, priority handling and multiplexing method for performing scheduling, priority handling and multiplexing on different logical channels in accordance with the invention. In step A, it calculates amount of data that can be transmitted for each logical channel with decreasing priority order, wherein data of each logical channel is divided into prioritized bit rate (PBR) data and non-PBR data. The detail flows can refer to FIG. 12(A), FIG. 12(B), and FIG. 12(C) for calculating data that can be transmitted with available resource for each logical channel. And only the calculated amount of data from each logical channel would be fit into the UL grants.

In step B, it prioritizes the logical channels with strict decreasing priority order. For example, logical channel 1 (CH1) can have higher priority than logical channel 2 (CH2) by configuration.

In step C, it initializes a variable m. In step D, it determines whether the variable m is equal to a number (M) of logical channels having data available for transmission;

In step E, it finds a UL grant or a combination of UL grants with least number of partitions that can allocate the data from the m-th logical channel if the variable m is not equal to the number of logical channels having data available for transmission. That is, the selected UL grant or combination of UL grants will have the least number, and have enough resource to allocate for all data from the m-th logical channel. It first tries whether each UL grant could be enough singly. If not, next it tries the combination of two UL grants, and then tries the combinations of three or more UL grants if needed.

In step F, it allocates resource with the UL grant or the combination of UL grants for data of the m-th logical channel.

In step G, it calculates a number of UL grants not exhausted and corresponding to remaining resource.

In step H, it increases the variable m and then goes to step D.

In step D, if the variable m is equal to the number of logical channels having data available for transmission, the method is ended.

As shown in FIG. 17, it is known that all the resource in the UL grants can be considered as a resource pool. The logical channels are served with decreasing priority order one after another. All the data in each logical channel corresponding to the calculated available resource can be fit in least number of UL grants or with least number of partitions. The UL grants or the combination of UL grants are tried one after another until the suitable UL grant or the combination of UL grants is found. The remaining resource in each UL grant or in the resource in the combination of UL grants will be calculated accordingly after the data in the logical channel has been fit in it. Then all the other logical channels will be tried sequentially with the same method disclosed in FIG. 17 to be fit in the remaining resource with least number of partitions.

In general, different component carriers (CCs) have different characteristics, and experience different radio conditions, so the channel quality on each CC will be different from UE's perspective. For each UE, the preference to each CC or the utilization priority for each CC may be different. As a result, different CCs could be assigned with different carrier priorities for increasing the transmission performance.

As each CC correspond to one HARQ entity, the configured priorities of CCs can also be considered as the configured priorities of the HARQ entities. Also as different UL grants are associated to different CCs, the configured priorities of CCs can also be considered as the priorities of the UL grants. The priorities of the grants could be considered as the values of their corresponding CCs. For example, one UL grant U1 is allocated on CC1, at the same time, another UL grant U2 is allocated on CC2, U1 will be considered with higher priority than U2 if CC1 has higher priority than CC2.

From another perspective view, the MAC Control Elements (excluding the ones of BSR for padding) have relatively higher priority over logical channel data, and all the logical channels are also ordered with index by priority.

Therefore, two kinds of priorities, i.e. CC priority and transmission data priority due to different logical channel and MAC control element, should be considered when UE performing scheduling, priority handling and multiplexing. Thus, in the following embodiments, the CC priority is also considered.

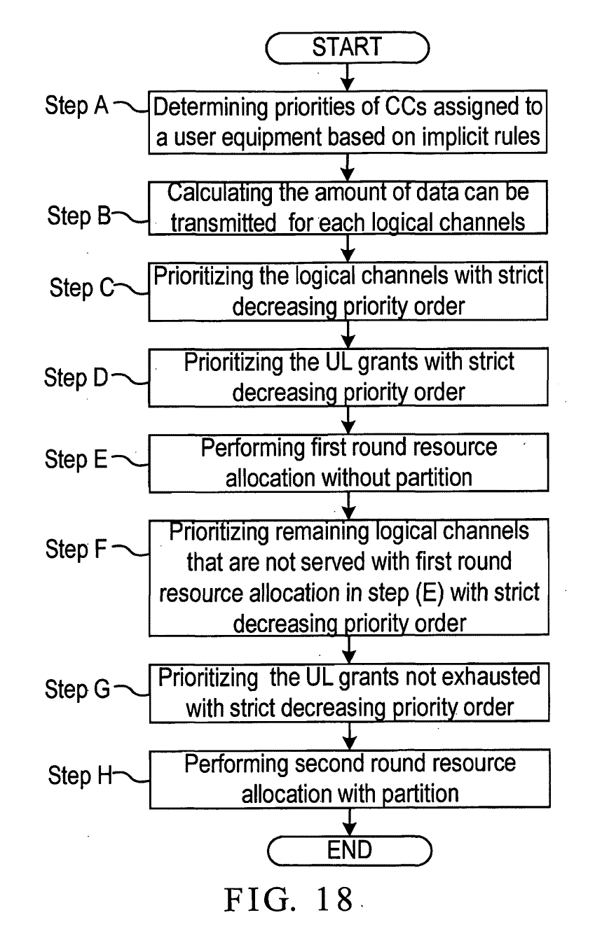

FIG. 18 shows a flow chart of an embodiment for enhanced scheduling, priority handling and multiplexing method for performing scheduling, priority handling and multiplexing on different logical channels with taking CC priority into consideration in accordance with the invention. In step A, the method determines priorities of CCs assigned to a user equipment (UE) based on implicit rules such as size of the allocated resource or carrier frequency of each UL grant. The priority information for configured CCs can be determined implicitly. For example, the priority information is calculated based on size of the allocated resource or carrier frequency of each UL grant. Another possibility is that the priority information for configured CCs assigned to the UE can be carried on a RRCConnectionReconfiguration signaling from a base station (eNB). The priority information for configured CCs is carried in the RRCConnectionReconfiguration signaling.

In step B, it calculates amount of data that can be transmitted for each logical channel with decreasing priority order, wherein data of each logical channel is divided into prioritized bit rate (PBR) data and non-PBR data.

In step C, it prioritizes the logical channels with strict decreasing priority order.

In step D, it prioritizes the UL grants with strict decreasing priority order according to the priorities of CCs assigned to the UE based on implicit rules maintained by the UE.

In step E, it performs first round resource allocation without partition.

In step F, it prioritizes remaining logical channels that are not performed with first round resource allocation in step (E) with strict decreasing priority order.

In step G, it prioritizes the UL grants not exhausted with strict decreasing priority order.

In step H, it performs second round resource allocation with partition.

In FIG. 18, the CC priority and transmission data priority are both considered, and the partition avoidance should be guaranteed first. In this method, UE has the preference to each CC, but the partition avoidance can be firstly guaranteed. UL grant is still treated jointly as an overall UL grant, and higher priority data is assigned to higher priority CC if possible. In this method, the logical channels are prioritized with strict decreasing priority order and the UL grant are utilized with strict decreasing CC priority order in the first round' resource allocation. In the second round resource allocation, the remaining logical channels are prioritized with strict decreasing priority order and the UL grant not exhausted are utilized with strict decreasing CC priority order. For example, if CC 1 associated to Grant1 has higher priority or better channel quality, UE will try to allocate higher priority data to CC1. The procedure is similar to what illustrated in FIG. 10. Although CH2 has higher priority over CH3, it is associated to Grant2, as the partition avoidance should be guaranteed first.

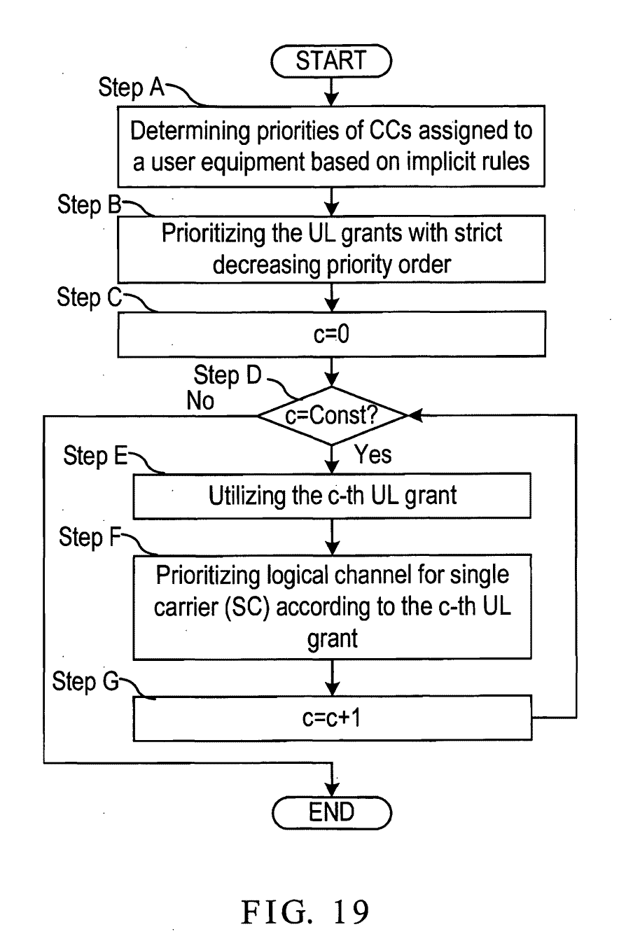

FIG. 19 shows a flow chart of another embodiment for enhanced scheduling, priority handling and multiplexing method for performing scheduling, priority handling and multiplexing on different logical channels with taking CC priority into consideration in accordance with the invention. In step A, the method determines priorities of CCs assigned to a user equipment (UE) based on implicit rules such as size of the allocated resource or carrier frequency of each UL grant. The priority information for configured CCs can be determined implicitly. For example, the priority information is calculated based on size of the allocated resource or carrier frequency of each UL grant. Another possibility is that the priority information for configured of CCs assigned to the UE can be carried on a RRCConnectionReconfiguration signaling from a base station. The priority information for configured CCs is carried in the RRCConnectionReconfiguration signaling.

In step B, it prioritizes the UL grants with strict decreasing priority order. In step C, it initializes a variable c.

In step D, it determines whether the variable c is equal to a number (Const) of UL grants. In step E, it utilizes the c-th UL grant. In step F, it prioritizes logical channel for single carrier (SC) according to the c-th UL grant. The detail flow for prioritizing logical channel for single carrier (SC) can refer to FIG. 3.

In step G, it increases the variable c and then executes step D. In step D, if the variable c is equal to the number of UL grants (Const), the method is ended.

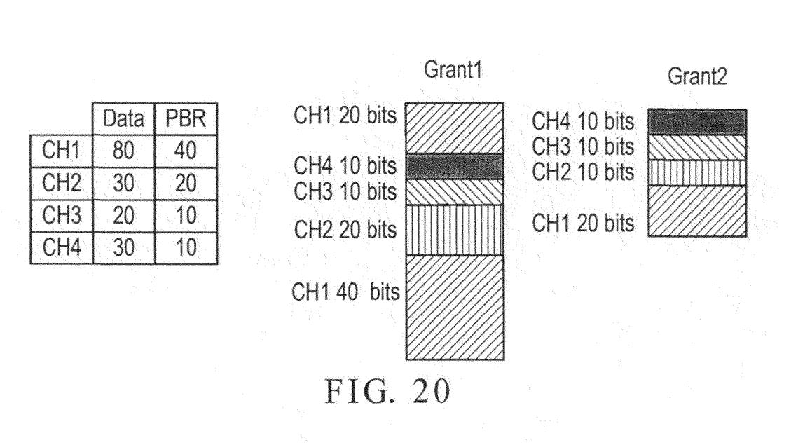

FIG. 20 schematically illustrates an example in accordance with the flow chart of FIG. 19. Assuming CC1 has higher priority than CC2. Logical channels are fit into the overall grant with decreasing priority order from CH1 to CH4. The resource allocation should meet the PBR for each logical channel. So 40 bits from CH1, 20 bits from CH2, 10 bits from CH3 and 10 bits from CH4 are fit into Grant1 respectively. Thus, there are 20 bits left in Grant1 and 50 bits left in Grant2.

As there are 70 bits left in the overall grant, 20 bits from CH1 are fit into Grant1 and there is no space left in Grant 1.

The rest 20 bits from CH1, 10 bits from CH2, 10 bits from CH3, and 10 bits from CH4 are fit into Grant 2.

With reference to FIG. 19 and FIG. 20, the CC priority and transmission data priority are both considered, and the CC priority should be considered first. In this embodiment, UE has the preference to each CC and always allocates higher priority data on the higher priority CC. With this requirement, UE should still try to guarantee partition avoidance while keeping data and channel priorities satisfied.

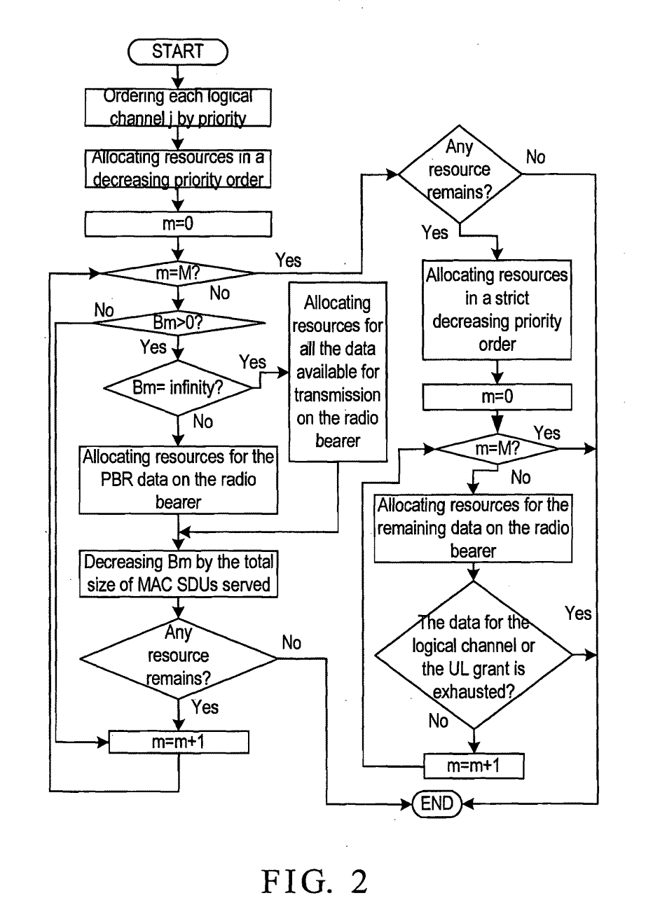

After PBR data allocation, non-PBR data on higher priority logical channel should always be allocated into the higher priority CC. With this method, the partition cannot be avoided. First, the resource for the PBR data for each logical channel is allocated. The procedure of the resource allocation for PBR data can reuse the exemplary flow chart in FIG. 2 for SC system. Then the non-PBR data on higher priority logical channel should always be allocated into the higher priority CC. The UL grants are utilized sequentially with strictly decreasing CC priority order and the logical channel prioritization for SC system can be reused.

The PBR data on lower priority logical channel are considered with higher priority than non-PBR data on higher priority logical channel, and allocated into higher priority CC.

In this embodiment, the PBR data is allocated to higher priority carrier, so that the transmission of PBR could be more ensured than non-PBR data. This is to avoid that the PBR data would arrive later than non-PBR data due to different channel quality.

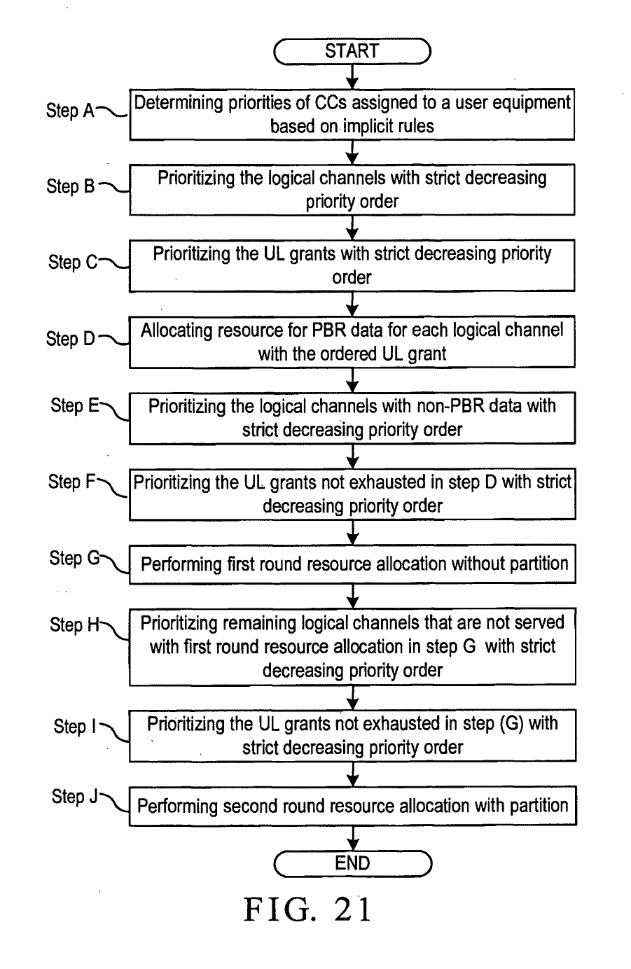

FIG. 21 shows a flow chart of further another embodiment for enhanced scheduling, priority handling and multiplexing method for performing scheduling, priority handling and multiplexing on different logical channels with taking CC priority into consideration in accordance with the invention. In step A, the method determines priorities of CCs assigned to a user equipment (UE) based on implicit rules. The priority information for configured CCs can be determined implicitly. For example, the priority information is calculated based on size of the allocated resource or carrier frequency of each UL grant. Another possibility is that the priority information for configured CCs assigned to UL grants in the UE can be carried on a RRCConnectionReconfiguration signaling from a base station. The priority information for configured CCs is carried in the RRCConnectionReconfiguration signaling.

In step B, it prioritizes the logical channels with strict decreasing priority order. In step C, it prioritizes the UL grants with strict decreasing priority order.

In step D, it allocates resource for prioritized bit rate (PBR) data for each logical channel with the prioritized UL grant.

In step E, it prioritizes the logical channels with non-PBR data with strict decreasing priority order.

In step F, it prioritizes the UL grants not exhausted in step D with strict decreasing priority order.

In step G, it performs first round resource allocation without partition.

In step H, it prioritizes remaining logical channels that are not performed with first round resource allocation in step G with strict decreasing priority order.

In step I, it prioritizes the UL grants not exhausted in step (G) with strict decreasing priority order.

In step J, it performs second round resource allocation with partition.

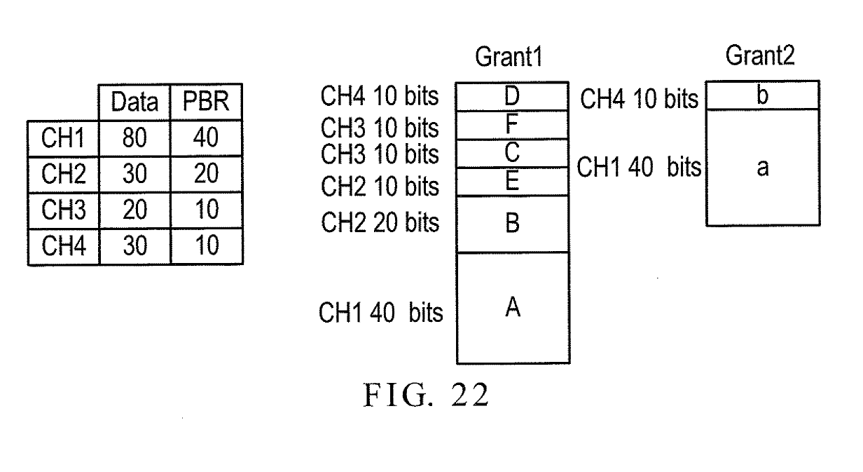

FIG. 22 schematically illustrates an example in accordance with the flow chart in FIG. 21. With an assumption that CC1 has higher priority than CC2 and logical channels are fit into the overall grant with decreasing priority order from CH1 to CH4. The resource allocation should meet the PBR for each logical channel. So 40 bits from CH1, 20 bits from CH2, 10 bits from CH3 and 10 bits from CH4 are fit into Grant1, in the regions A, B, C, and D respectively. Thus, there are 20 bits left in Grant1 and 50 bits left in Grant2.

If the UE continues to fit data of CH1 in Grant1, only 20 bits can be fit in. Another 20 bits in Grant2 is required, and 4 partitions will be needed as indicated in FIG. 20. If the method fits the 40 bits from CH1 in Grant2, all left data of CH2 and CH3 can be fit into Grant1, and only 2 partitions is needed. So the UE fits the 40 bits from CH1 into the region a of Grant2.

There are 30 bits left in the overall grant, and 10 bits from CH2 are fit into the region E of Grant1.

There are 20 bits left in the overall grant, and 10 bits from CH3 are fit into the region F of Grant1, while there is no space left in Grant1.

There are 10 bits left in the overall grant, and 10 bits from CH4 are fit into the region b of Grant2.

From FIG. 21 and FIG. 22, it is known that the partition avoidance for non-PBR data on higher priority logical channel should be tried to be guaranteed after PBR data allocation.

Partition avoidance for non-PBR data can reuse the algorithm illustrated in FIG. 14 and FIG. 15 with the first and the second round resource allocation. After PBR data allocation, non-PBR data in the logical channels are prioritized with strict decreasing priority order and the UL grants are prioritized with strict decreasing CC priority order in the first round resource allocation. Then the second round resource allocation is performed.

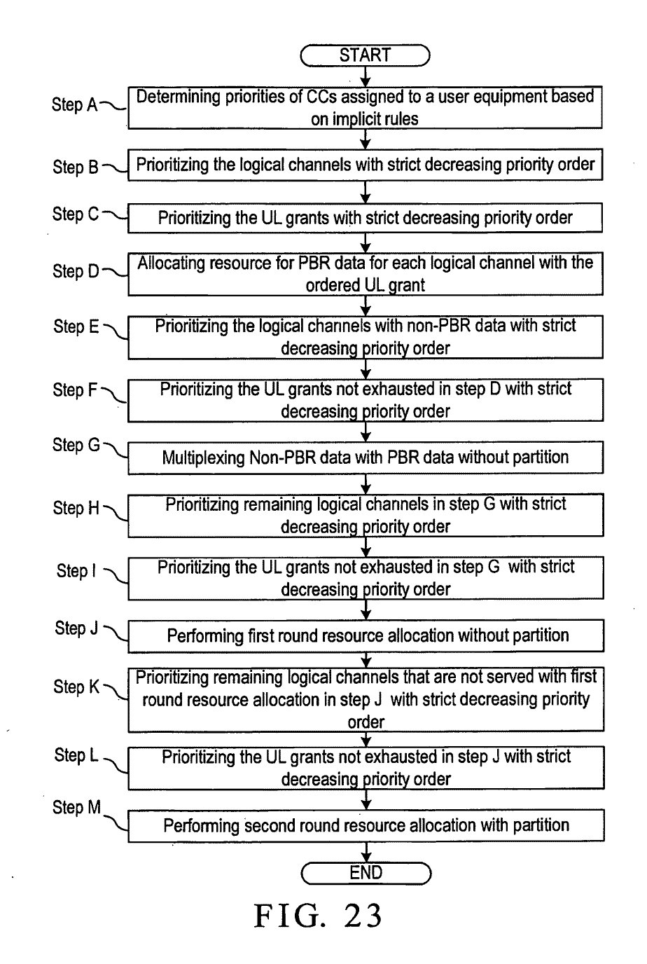

FIG. 23 shows a flow chart of further another embodiment for enhanced scheduling, priority handling and multiplexing method for performing scheduling, priority handling and multiplexing on transmitting data of different logical channels with taking CC priority into consideration in accordance with the invention. In step A, the method determines priorities of CCs assigned to a user equipment (UE) based on implicit rules. The priority information for configured CCs can be determined implicitly. For example, the priority information is calculated based on size of the allocated resource or carrier frequency of each UL grant. Another possibility is that the priority information for configured CCs assigned to UL grants in the UE can be carried on a RRCConnectionReconfiguration signaling from a base station. The priority information for configured CCs is carried in the RRCConnectionReconfiguration signaling.

In step B, it prioritizes the logical channels with strict decreasing priority order. In step C, it prioritizes the UL grants with strict decreasing priority order.

In step D, it allocates resource for prioritized bit rate (PBR) data for each logical channel with the prioritized UL grant.

In step E, it prioritizes the logical channels with non-PBR data with strict decreasing priority order.

In step F, it prioritizes the UL grants not exhausted in step D with strict decreasing priority order.

In step G, it multiplexes Non-PBR data with PBR data without partition. The detail flow for multiplexing Non-PBR data with PBR data without partition is described in later.

In step H, it prioritizes remaining logical channels in step (G) with strict decreasing priority order.

In step I, it prioritizes the UL grants not exhausted in step (G) with strict decreasing priority order.

In step J, it performs first round resource allocation without partition.

In step K, it prioritizes remaining logical channels that are not served with first round resource allocation in step (J) with strict decreasing priority order.

In step L, it prioritizes he UL grants not exhausted in step (J) with strict decreasing priority order.

In step M, it performs second round resource allocation with partition.

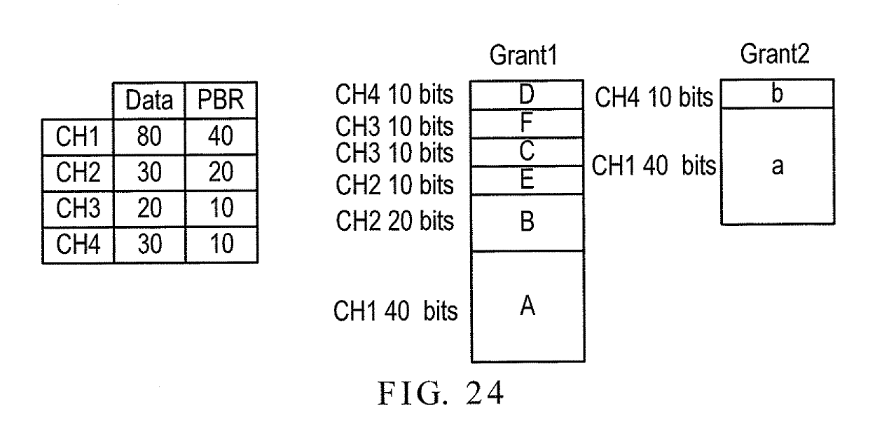

FIG. 24 schematically illustrates an example in accordance with the flow chart in FIG. 23. With an assumption that CC1 has higher priority than CC2 and logical channels are fit into the overall grant with decreasing priority order from CH1 to CH4. The resource allocation should meet the PBR for each logical channel. So 40 bits from CH1, 20 bits from CH2, 10 bits from CH3 and 10 bits from CH4 are fit into Grant1, in the regions A, B, C, and D respectively. Thus, there are 20 bits left in Grant1 and 50 bits left in Grant2.

Grant1 has PBR data from CH1, but non-PBR data from CH1 can not be multiplexed with PBR data without partition, because only 20 bits left in Grant1. So it tries to allocate resource for CH2. As non-PBR data from CH2 can be multiplexed with PBR data without partition, 10 bits from CH2 is fit in region E of Grant1. Then CH3 is tried as there is 10 bits left in Grant1. As non-PBR data from CH3 can be multiplexed with PBR data without partition, 10 bits from CH3 is fit in region F of Grant1.

Thus, there are 50 bits left in the overall grant, 40 bits from CH1 are fit into the region a of Grant2.

Then, there are 10 bits left in the overall grant, 10 bits from CH4 are fit into the region b of Grant2.

From FIG. 23 and FIG. 24, it is known that, after PBR data allocation, non-PBR data of each logical channel are tried to be multiplexed with PBR data if partition can be avoided. After non-PBR data multiplexed with PBR data, non-PBR data in the remaining logical channels are served with strict decreasing priority order and the UL grants not exhausted are utilized with strict decreasing CC priority order in the first round resource allocation. Then the second round resource allocation is performed.

After PBR data allocation, partition avoidance for data on higher priority logical channel should be guaranteed, i.e. non-PBR data from higher priority logical channel should be tried to be multiplexed with PBR data into the same transport block.

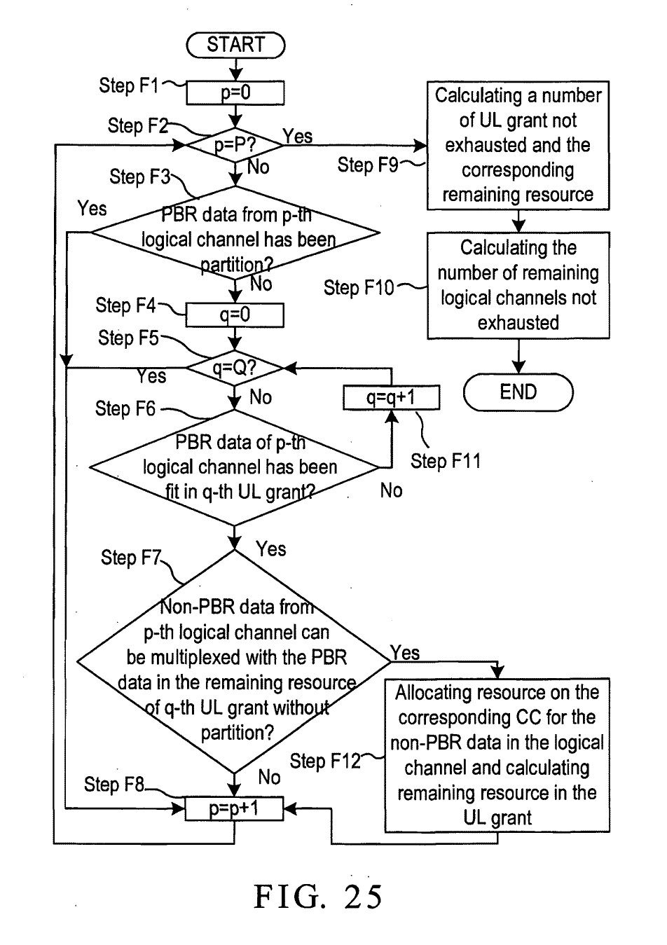

FIG. 25 is a flow chart of method to realize the non-PBR data multiplexed with PBR data into the same transport block. In step F1, it initializes a fifth variable p. The fifth variable p represents an index of logical channels which still have remaining non-PBR data.

In step F2, it determines whether the fifth variable p is equal to a number of logical channels which still have remaining non-PBR data (P).

In step F3, it determines whether the PBR data from p-th logical channel has been partitioned if the fifth variable m is not equal to the number of logical channels which still have remaining non-PBR data, where p is a value of the fifth variable. Note that if the PBR data from the p-th logical channel has been fit into the whole resource of a UL grant, which result in that no additional data can be fit into the UL grant at all, the PBR data from the p-th logical channel is considered as being partitioned.

In step F4, it initializes a sixth variable q if the PBR data from p-th logical channel has not been partitioned. The sixth variable q represents an index of UL grants not exhausted.

In step F5, it determines whether sixth variable (q) is equal to a number of UL grants not exhausted (Q).

In step F6, it determines whether the PBR data of p-th logical channel has been fit in q-th LTL grant if the sixth variable (q) is not equal to the number of UL grants not exhausted, where q is a value of the sixth variable.

In step F7, it determines whether the non-PBR data from p-th logical channel can be multiplexed with the PBR data in the remaining resource of q-th UL grant without partition if the PBR data of p-th logical channel has been fit in q-th UL grant.

In step F8, it increases the fifth variable p and executing step F2 if the non-PBR data from p-th logical channel cannot be multiplexed with the PBR data in the remaining resource of q-th UL grant without partition.

In step F9, it calculates a number of UL grant not exhausted and the corresponding remaining resource if the fifth variable p is equal to the number of logical channels which still have remaining non-PBR data.

In step F10, it calculates the number of remaining logical channels not exhausted.

In step F11, it increases the sixth variable q and executing step F5 if the PBR data of p-th logical channel has not been fit in q-th UL grant.

In step F12, it allocates resource on the corresponding CC for the non-PBR data in the logical channel and calculates remaining resource in the UL grant and executing step (F8) if the non-PBR data from p-th logical channel can be multiplexed with the PBR data in the remaining resource of q-th UL grant without partition.

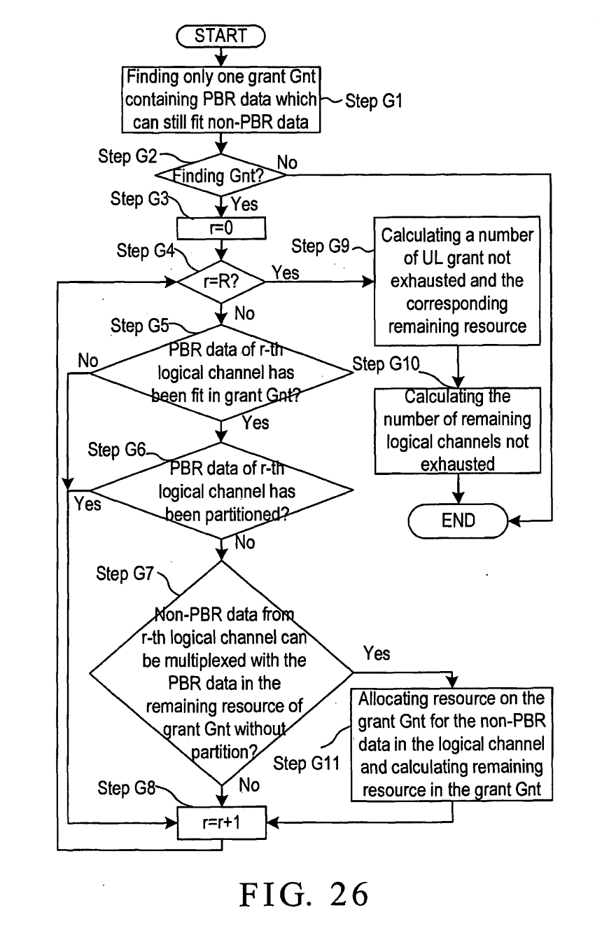

As shown in FIG. 25, it is known that the logical channels are served one after another with the logical channel priority order. If the PBR data in the logical channel has been partitioned, the non-PBR data in the logical channel is not served. Otherwise, The UL grants are tried one after another with the CC priority order until the right UL grant in which the PBR data from the logical channel has been fit is found. Then it should be decided whether the non-PBR data from the logical channel can be multiplexed with the PBR data in the right UL grant without partition. If partition can be avoided, resource will be allocated to the non-PBR data of the logical channel and the remaining resource in the right UL grant will be calculated. Otherwise, the non-PBR data in the logical channel is not served. Then all the other logical channels will be tried sequentially with the same method described above. With this method, the non-PBR data from each logical channel can be multiplexed with the PBR data without partition if possible. After the non-PBR data in all the logical channels are treated, the number of remaining logical channels not exhausted and the number of UL grant not exhausted as well as the corresponding remaining resource are calculated. FIG. 26 is another flow chart of method to realize the non-PBR data multiplexed with PBR data into the same transport block. In step G1, it finds the only one grant Gnt containing PBR data which can still fit non-PBR data.

In step G2, it determines whether grant Gnt is found.

In step G3, it initializes a seventh variable r if the grant Gnt is found. The seventh variable r represents an index of logical channels which still have remaining non-PBR data.

In step G4, it determines whether the seventh variable r is equal to a number of logical channels which still have remaining non-PBR data R;

In step G5, it determines whether the PBR data from r-th logical channel has been fit in the grant Gnt if the seventh variable r is not equal to the number of logical channels which still have remaining non-PBR data, where r is a value of the seventh variable.

In step G6, it determines whether the PBR data of r-th logical channel has been partitioned if the PBR data from r-th logical channel has been fit in the grant G

In step G7, it determining whether the non-PBR data from r-th logical channel can be multiplexed with the PBR data in the remaining resource of grant Gnt without partition if the PBR data of r-th logical channel has not been partitioned.

In step G8, it increases the seventh variable r and executing step G4 if the non-PBR data from r-th logical channel cannot be multiplexed with the PBR data in the remaining resource of grant Gnt without partition.

In step G9, it calculates a number of UL grant not exhausted and the corresponding remaining resource if the seventh variable r is equal to the number of logical channels which still have remaining non-PBR data.

In step G10, it calculates the number of remaining logical channels not exhausted.

In step G11, it allocates resource on the grant Gnt for the non-PBR data in the logical channel and calculating remaining resource in the grant Gnt and executing step G8 if the non-PBR data from r-th logical channel can be multiplexed with the PBR data in the remaining resource of grant Gnt without partition.

As shown in FIG. 26, the UE first tries to find the only grant Gnt containing PBR data and still has space to fit more non-PBR data. If no such grant is found, the method ends. Next the logical channels with PBR data fit in the grant Gnt are served with strict decreasing priority order. But if a logical channel has PBR data in the grant Gnt, but the PBR data was partitioned so that the PBR data also fit in another grant, such a logical channel would not be served. Only the logical channels with non-partitioned PBR data fit in the grant Gnt are served.

Similar to what is illustrated in FIG. 25, the chosen logical channels are taken into consideration whether the non-PBR data from the selected logical channels can be multiplexed with the PBR data in the grant Gnt without partition. If partition can be avoided, resource will be allocated to the non-PBR data of the logical channel, and the remaining resource in the grant Gnt will be calculated. Otherwise, the non-PBR data in the logical channel is not served. One after another, all the chosen logical channels will be tried sequentially with the same method described above. With this method, the non-PBR data from each logical channel can be multiplexed with the PBR data without partition if possible. After the non-PBR data in all the logical channels are treated, the number of remaining logical channels not exhausted and the number of UL grant not exhausted as well as the corresponding remaining resource are calculated.

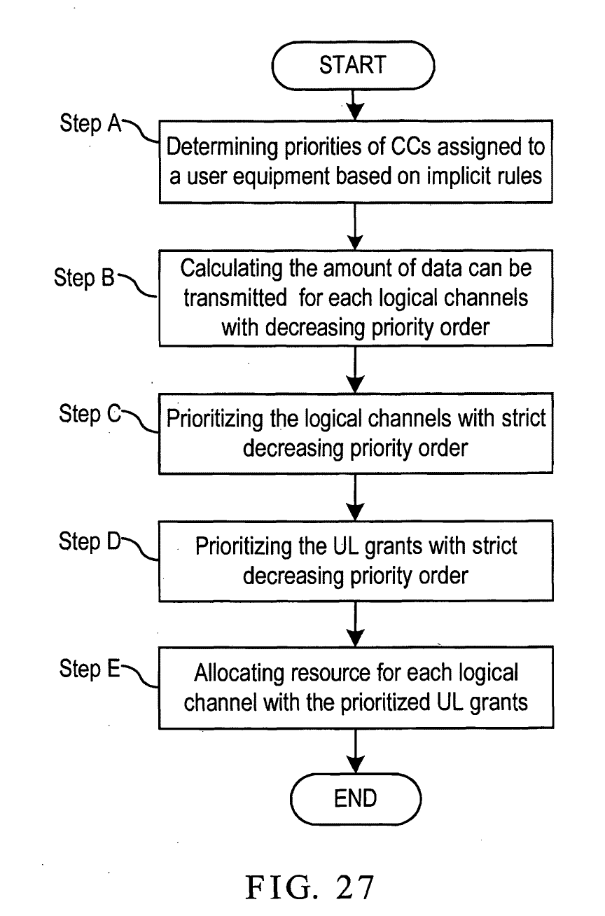

FIG. 27 shows a flow chart of further another embodiment for enhanced scheduling, priority handling and multiplexing method for performing scheduling, priority handling and multiplexing on different logical channels with taking CC priority into consideration in accordance with the invention. In step A, the method determines priorities of CCs assigned to a user equipment (UE) based on implicit rules. The priority information for configured CCs can be determined implicitly. For example, the priority information is calculated based on size of the allocated resource or carrier frequency of each UL grant. Another possibility is that the priority information for configured CCs assigned to UL grants in the UE can be carried on a RRCConnectionReconfiguration signaling from a base station.

In step B, the method calculates data that can be transmitted for each logical channel with decreasing priority order, wherein data of each logical channel is divided into prioritized bit rate (PBR) data and non-PBR data.

In step C, it prioritizes the logical channels with strict decreasing priority order.

In step D, it prioritizes the UL grants with strict decreasing priority order.

In step E, it allocates resource for each logical channel with the prioritized UL grants.

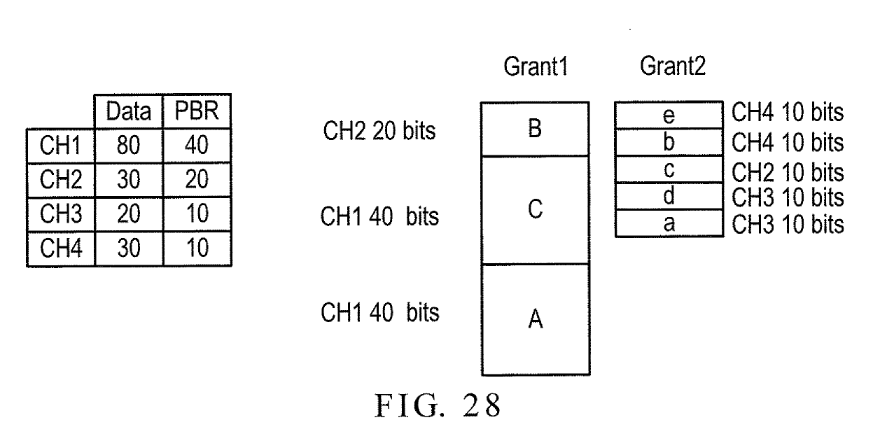

FIG. 28 schematically illustrates an example in accordance with the flow chart in FIG. 27. It is assumed that CC1 has higher priority than CC2. Although PBRs of different logical channels are guaranteed to be satisfied, the data coming from same logical channel are kept together as much as possible. Logical channels are fit into the overall grant with decreasing priority order from CH1 to CH4. The resource allocation should meet the PBR for each logical channel. So 40 bits from CH1, 20 bits from CH2, 10 bits from CH3 and 10 bits from CH4 are fit into Grant1 and Grant2, in the region A of Grant1, B of Grant1, a of Grant2, b of Grant2 respectively. So there are 40 bits left in Grant1 and 30 bits left in Grant2.

As there are 70 bits left in the overall grant, 40 bits from CH1 are fit into the region C of Grant1. There is no space left in Grant 1.

There are 30 bits left in Grant2, and 10 bits from CH2 are fit into the region c of Grant2.

There are 20 bits left in Grant2, and 10 bits from CH3 are fit into the region d of Grant2.

There are 10 bits left in Grant2, and 10 bits from CH4 are fit into the region e of Grant2.

As shown in FIG. 27 and FIG. 28, the non-PBR data of higher priority logical channel is allocated to higher priority carrier, so that the transmission of data on the same logical channel could be better guaranteed to arrive in the same grant. This is to avoid that the data from same logical channel would be partitioned and delayed due to different channel quality.

It is known that the invention provides enhanced scheduling, priority handling and multiplexing method and system for performing scheduling, priority handling and multiplexing on different logical channels to be used for the carrier aggregation procedure in LTE-A. In the present invention, the processor 415 determines and maintains the priorities of received UL grants, each associated to a CC, manages the received UL grants sequentially or jointly as an overall UL grant when performing scheduling, priority handling and multiplexing. The processor 415 manages the received UL grants jointly by allocating data to another carrier before exhausting the UL grant of one carrier. If the UL grants are treated as an overall UL grant, RLC SDUs from the same logical channel should be multiplexed into the same transport block; i.e. partition avoidance should be tried to be guaranteed.

In the invention, to achieve the partition avoidance is to first calculate the data that can be transmitted for each logical channel with the available resource with decreasing priority order, and then RLC SDUs from each logical channel should be tried to be fit into only one CC. Accordingly, partition avoidance can be guaranteed firstly for higher priority logical channel. If the logical channel priority is considered, the number of partition for higher priority logical channel can be minimized. Regardless of logical channel priority, partition avoidance can be guaranteed in a way to minimize the overall partition number.

Based on the technology of the invention, a user equipment determines and maintains the priorities of CCs assigned to it, based on implicit, i.e. without an explicit signaling from the network, rules such as the size of the allocated resource, or the carrier frequency of each UL grant. So the CC priorities can be considered when performing scheduling, priority handling and multiplexing on different logical channels to be used for the carrier aggregation procedure in LTE-A.

Based on the technology of the invention, if CC priority and transmission data priority are both considered and partition avoidance is guaranteed first, UE tries to allocate higher priority data to the higher priority CC, and RLC SDUs from higher priority logical channel can be avoided from being multiplexed to different transport blocks.

If CC priority is considered and the PBR data on lower priority logical channel are considered with higher priority than non-PBR data on higher priority logical channel, UE of the invention allocates the PBR data from each logical channel to the higher priority CC according to the decreasing logical channel priority.

After PBR data allocation, in the invention, non-PBR data on higher priority logical channel can always be allocated into the higher priority CC, or partition avoidance for non-PBR data on higher priority logical channel can be tried to be guaranteed, or partition avoidance for data on higher priority logical channel should be tried to be guaranteed.

If CC priority is considered and the non-PBR data on higher priority logical channel are considered with higher priority than PBR data on lower priority logical channel, UE of the invention allocates data from higher priority logical channel to the higher priority CC. RLC SDUs from higher priority logical channel can be avoided from being multiplexed to different transport blocks.

It can be seen that multiple UL grants and multiple HARQ entities can be considered jointly and partition avoidance can be guaranteed firstly for higher priority logical channel, thereby achieving the efficiency of resource allocation in the invention.

Although the present invention has been explained in relation to its preferred embodiment, it is to be understood that many other possible modifications and variations can be made without departing from the spirit and scope of the invention as hereinafter claimed.

What is claimed is:

1. An enhanced scheduling, priority handling and multiplexing method, applied in transmitting data of logical channels in long term evolution (LTE) system, comprising the steps of:
(A) calculating the data that can be transmitted with available resource for the logical channels respectively, wherein the data of each the logical channel is divided into a prioritized bit rate (PBR) data and a non-PBR data;
(B) prioritizing the logical channels with a decreasing priority order;
(C) performing a first round resource allocation without partition;
(D) prioritizing the logical channels with remaining data that is not served with the first round resource allocation with the decreasing priority order; and
(E) performing a second round resource allocation with partition.

2. The method of claim 1, wherein the step (A) comprising:
(A1) determining the available resource to transmit the data from the logical channels which can be transmitted with uplink (UL) grants; and
(A2) calculating the data of the logical channels that can be transmitted the remaining resource calculated in Step (A1).

3. The method of claim 1, wherein the step (C) comprising:
(C1) initializing a first variable;
(C2) determining whether the first variable is equal to a number of the logical channels having the data available for transmission;
(C3) initializing a second variable when the first variable is not equal to the number of logical channels having the data available for transmission;
(C4) determining whether the second variable is equal to a number of received UL grants;
(C5) determining whether the data that can be transmitted for an m-th logical channel can be fit into the remaining resource in a c-th UL grant when the second variable is not equal to the number of the received UL grant, where m is a value of the first variable;
(C6) allocating resource on the c-th UL grant for the data in the m-th logical channel and calculating the remaining resource in the c-th UL grant, where c is a value of the second variable; and
(C7) increasing the first variable and executing step (C2).

4. The method of claim 3, wherein the step (C) further comprising:
(C8) calculating a number of the UL grants not exhausted and the remaining resource of the UL grants not exhausted when the first variable is equal to the number of the logical channels having data available for transmission; and
(C9) calculating a number of the remaining logical channels not exhausted, treating the remaining logical channels with the decreasing priority order, and executing step (D).

5. The method of claim 4, wherein the step (C) further comprising:
(C10) increasing the second variable and executing step (C4).

6. The method claim 5, wherein the step (E) comprising:
(E1) initializing a third variable and a counting variable;
(E2) determining whether the third variable is equal to the number of the remaining logical channels not exhausted;
(E3) initializing a fourth variable when the third variable is not equal to the number of the remaining logical channels not exhausted;
(E4) determining whether the fourth variable is equal to the number of the UL grants not exhausted;
(E5) determining whether the j-th UL grant is exhausted when the fourth variable is not equal to the number of the UL grants not exhausted, where j is a value of the fourth variable;
(E6) partitioning the data from the k-th logical channel, where k is a value of the third variable;
(E7) increasing the counting variable;
(E8) allocating the resource with the j-th UL grant for the data partitioned from the k-th logical channel in step (E6);
(E9) determining whether the data that can be transmitted for the k-th logical channel is all allocated;
(E10) increasing the third variable when data that can be transmitted for the k-th logical channel is all allocated and executing step (E2), otherwise, increasing the fourth variable and executing step (E4).

7. The method of claim 6, wherein the step (E) further comprising:
(E11) ending the method when the third variable is equal to the number of the remaining logical channels not exhausted or the fourth variable is equal to the number of UL grants not exhausted.

8. An enhanced scheduling, priority handling and multiplexing method, applied in transmitting data of logical channels in LTE system, comprising the steps of:
(A) calculating the data that can be transmitted for the logical channels with decreasing priority order, wherein the data of the logical channels is divides into prioritized bit rate (PBR) data and non-PBR data;
(B) prioritizing the logical channels with the decreasing priority order;
(C) initializing a first variable;
(D) determining whether the first variable is equal to a number of the logical channels having data available for transmission;
(E) finding a UL grant or a combination of UL grants with least number of partitions when the first variable is not equal to the number of logical channels having the data available for transmission;
(F) allocating resource with the UL grant or the combination of UL grants for data of the m-th logical channel, where m is a value of the first variable;
(G) calculating a number of UL grants not exhausted and corresponding remaining resource; and
(H) increasing the first variable and going to step (D).

9. The method of claim 8, further comprising:
(I) ending the method when the first variable is equal to the number of the logical channels having data available for transmission.

10. An enhanced scheduling, priority handling and multiplexing method, applied in transmitting data of logical channels in LTE system, comprising the steps of:
(A) determining priorities of component carriers (CCs) assigned to a user equipment based on implicit rules;
(B) calculating amount of data that can be transmitted for the logical channels respectively, wherein the data of the logical channel is divided into a prioritized bit rate (PBR) data and a non-PBR data;
(C) prioritizing the logical channels with a decreasing priority order;
(D) prioritizing uplink (UL) grants with the decreasing priority order;
(E) performing a first round resource allocation without partition;
(F) prioritizing remaining logical channels that are not performed with the first round resource allocation in step (E) with the decreasing priority order;
(G) prioritizing the UL grants not exhausted with the decreasing priority order; and
(H) performing a second round resource allocation with partition.

11. The method of claim 10, wherein the priority information is maintained by the UE implicitly.

12. The method of claim 11, wherein the priority information is calculated based on size of the allocated resource of each UL grant.

13. An enhanced scheduling, priority handling and multiplexing method, applied in transmitting data of logical channels in LTE system, comprising the steps of:
(A) determining priorities of component carriers (CCs) assigned to a user equipment based on implicit rules;
(B) calculating the data that can be transmitted for the logical channels respectively, wherein the data of the logical channel is divided into a prioritized bit rate (PBR) data and a non-PBR data;
(C) prioritizing the logical channels with a decreasing priority order;
(D) prioritizing uplink (UL) grants with the decreasing priority order; and
(E) allocating resource for each logical channel with the prioritized UL grants.

14. An enhanced scheduling, priority handling and multiplexing system, applied in transmitting data of logical channels in LTE system, comprising.:
a receiver, for receiving a payload unit; and
a processor, for processing the payload unit and enhancing scheduling, priority handling and multiplexing on the logical channels,
wherein the processor determines priorities of received uplink (UL) grants, each being associated to a component carrier (CC), manages the received UL grants sequentially or jointly as an overall UL grant when performing scheduling, priority handling and multiplexing on transmitting data of logical channels.

15. The system of claim 14, wherein when the UL grants are treated as the overall UL grant, partition avoidance is to be guaranteed, and the partition avoidance is referred as radio link control service data units (RLC SDUs) from the same logical channel are multiplexed into same transport block.

16. The system of claim 15, wherein the partition avoidance is implemented by calculating the data that can be transmitted for the logical channels with available resource by a decreasing priority order, and then fitting the RLC SDUs from the logical channels into only one component carrier (CC).

17. The system of claim 16, wherein CC priority is considered and prioritized bit rate (PBR) data on the logical channel with lower priority are considered with higher priority than the non-PBR data on the logical channel with the higher priority, and the processor allocates the PBR data from the logical channels to the higher priority CC based on a decreasing logical channel priority.

18. The system of claim 17, wherein after PBR data allocation, the non-PBR data on the logical channel with higher priority are allocated into the higher priority CC, or partition avoidance for the non-PBR data on the logical channel with the higher priority is guaranteed, or the partition avoidance for data on the logical channel with the higher priority is guaranteed.

19. The system of claim 16, wherein the CC priority is considered and the non-PBR data on the logical channel with the higher priority are considered with the higher priority than the PBR data on the logical channel with the lower priority, the processor allocates data from the logical channel with the higher priority to the higher priority CC, and the RLC SDUs from the logical channel with the higher priority are avoided to be multiplexed to different transport blocks.
